(19) United States
(12) Patent Application Publication
(10) Pub. No.: US 2026/0142821 A1
(43) Pub. Date: May 21, 2026

(54) Systems and Methods for Incrementally Verifying Distributed Computation Across Multiple Untrusted Nodes

(71) Applicant: NTT Research, Inc., Sunnyvale, CA (US)

(72) Inventors: Pratish Datta, Sunnyvale, CA (US); Abhishek Jain, Baltimore, MD (US); Zhengzhong Jin, Boston, MA (US); Alexis Korb, Los Angeles, CA (US); Surya Mathialagan, Boston, MA (US); Amit Sahai, Los Angeles, CA (US)

(73) Assignee: NTT Research, Inc., Sunnyvale, CA (US)

(21) Appl. No.: 19/397,764

(22) Filed: Nov. 21, 2025

Related U.S. Application Data
(60) Provisional application No. 63/723,257, filed on Nov. 21, 2024.

(51) Int. Cl. H04L 9/32; H04L 9/30

(52) U.S. Cl. CPC H04L 9/3218; H04L 9/3006

(57) ABSTRACT

A method and system for verifying distributed computations across multiple untrusted computing nodes. A setup entity generates cryptographic reference strings including succinct non-interactive arguments (SNARGs) and batch arguments (seBARGs) for multiple proof hierarchy levels. Prover entities compute state transitions using nondeterministic inputs, generate proofs for individual computation steps, and merge proofs hierarchically to create compact proofs whose size grows logarithmically with computation length rather than linearly. A verifier entity validates the merged proofs at each level. In a zero-knowledge variant, the setup entity additionally generates encryption keys and zero-knowledge proof parameters. Prover entities encrypt all computation states and wrap proofs in zero-knowledge layers, hiding sensitive intermediate values and witnesses while maintaining verifiability.

### CROSS-REFERENCE TO RELATED APPLICATION

This application claims the benefit of U.S. Provisional Application Ser. No. 63/723,257 filed Nov. 21, 2024, the content of which is incorporated by reference herein in its entirety for all purposes.

### FIELD OF THE INVENTION

The present disclosure relates to verifiable computation systems, and more particularly to incrementally verifiable computation schemes for NP-complete problems based on standard cryptographic assumptions.

### BACKGROUND OF THE INVENTION

Suppose humanity faces a difficult mathematical problem: x₀. A mathematician, through hard work, reduces x₀ to a simpler problem x₁ with a proof w₁. Later, another mathematician reduces x₁ to x₂ via a long proof w₂. Different mathematicians may explore various paths, possibly reducing x₁ to other problems like

$${x}_{2}^{′} \neq {x}_{2} .$$

Eventually, after many steps (and perhaps many generations), we obtain a long chain of reductions: x₀→x₁→ . . . →x_{T}, where x_{T} is an easily verifiable tautology.

To verify the correctness of this long sequence, one traditionally needs to go through all intermediate proofs, which can be time-consuming. Now, imagine that at each step i, the mathematician attaches a certificate πᵢ to demonstrate that there exists a valid proof from x₀ to xᵢ. Moreover, this certificate πᵢ can be generated efficiently from the proof wᵢ of the reduction xᵢ₋₁→xᵢ and the previous certificate πᵢ₋₁. If this process can be done incrementally, then the final certificate at step T could be verified in time much less than T (ideally, in poly(log T) time).

This concept was introduced in prior work as incrementally verifiable computation (IVC). IVC extends the notion of succinct non-interactive arguments (SNARGs). Recall that SNARGs for NP enable a prover to compress an NP witness into a short certificate that can be verified in near-linear time. IVC extends SNARGs by allowing the prover to incrementally update the SNARG proof as the computation progresses. As motivated in our earlier example, the setup is as follows: there is a starting configuration aro, and a machine M (possibly nondeterministic) that can be applied to x₀ to reach a new state. In an IVC scheme, as in the SNARG setting, a user should be able to produce a proof π that a state x₀ reaches a state [symbol] in [symbol] non-deterministic steps, if the user is aware of the non-deterministic choices that were made to reach [symbol] . Additionally, we want to be able to update the proof a to prove that x₀ reaches some state [symbol] =M( [symbol] ) only knowing x₀, [symbol] , [symbol] , π, and [symbol] ; that is, without knowing the earlier non-deterministic choices made. Crucially, we want that neither update time, verification time, nor proof size scale with [symbol] . The case where M is a deterministic procedure that does not take an auxillary input is called IVC for P, or IVC for deterministic computations.

IVC and its generalizations have enabled a plethora of applications, including enforcing language semantics, authenticating images, blockchains and many more. Some of these applications additionally require the proof to satisfy the zero knowledge property, namely, that the proof reveals nothing beyond the validity of the statement. This property is essential, for example, in the case of image authentication where we want to be able to prove that images appearing in news articles underwent an approved set of transformations from the time of creation. The zero-knowledge property allows reporters to hide sensitive information, while still proving the authenticity of the image.

In his work that introduced IVC, Valiant provided a construction via Micali's CS proofs, and proved its security in a non-standard version of the random oracle model that assumes a succinct description of the oracle. Then, prior works constructed IVC for NP, and more generally proof-carrying data (PCD) (Proof-carrying data (PCD) is a generalization of IVC introduced in prior work. Here, the computation can be performed on arbitrary communication graphs. IVC can be seen as a special case of PCD where the communication occurs in a path.), via SNARKs (succinct non-interactive argument of knowledge), folding schemes, arithmetized random oracles and many more. However, all of these constructions involve either idealized models or non-standard knowledge assumptions. In fact, SNARKs are known to be impossible to achieve via black-box reductions to standard assumptions. Recent works also present barriers to achieving IVC for NP in the random oracle model.

Several works have studied the problem of constructing IVC for P from standard assumptions, with the recent works of Paneth and Pass and Devadas, Goyal, Kalai and Vaikuntanthan achieving a proof size of poly(|x|, λ) from standard assumptions such as Learning with Errors (LWE). However, IVC for NP is more desirable in practice. For example, in the aforementioned mathematical proof scenario, scientific research is a non-deterministic process rather than a deterministic one. Moreover, when IVC is used on the blockchain to verify virtual machine execution, the virtual machine can take additional transactions as input in each step of the execution, making it naturally a non-deterministic computation.

This leads to our central question: Can we build incrementally verifiable computation for NP from standard assumptions?

Despite its significance, IVC for NP from standard assumptions has remained elusive. The difficulty lies in the fundamental differences between P and NP. IVC for NP allows the prover to certify multiple computation paths, as they can choose the NP witness, whereas IVC for P has a unique computation path. This flexibility in NP computations complicates the construction of IVC for NP but also enables a wider range of applications.

A similar difficulty arises in the context of SNARGs. While we know how to build SNARGs for P from a variety of standard assumptions, constructing SNARGs for NP has so far required the heavier machinery of indistinguishability obfuscation, which itself can be based on standard assumptions.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Incrementally verifiable computation (IVC) is a notion introduced by Valiant [TCC '08] where a prover is able to iteratively prove that a configuration x₀ reaches a configuration x_{T} after repeated application of a transition function [symbol] . Crucially, the size of the proof and the time to update the proof does not scale polynomially with the number of time-steps T. This problem is known as IVC for P.

IVC of NP extends this notion to the setting where we allow [symbol] to be a non-deterministic computation, i.e. a configuration xᵢ is reachable from xᵢ₋₁ if there exists some additional input (or witness) wᵢ such that [symbol] (xᵢ₋₁, wᵢ)=xᵢ. This notion of IVC is necessary for many applications. While many constructions of IVC for NP exist from either knowledge assumptions or in idealized models, unlike IVC for P, there are no known constructions from standard falsifiable assumptions. As pointed out in many works, since IVC for NP would also imply adaptive SNARGs for NP, the impossibility result of Gentry-Wichs [STOC '11] poses some barriers to constructing IVC for NP from falsifiable assumptions.

In this work, we show that we can in fact construct IVC for NP from standard assumptions where the proof size only grows polylogarithmically with T. Our contributions are as follows:
Assuming either subexponential LWE or subexponential bilinear maps, we obtain proofs of size poly(λ, |xᵢ|, |w|, log T).
Additionally assuming subexponential i [symbol] , or more generally, any non-adaptive SNARG for NP, we obtain proofs of size poly(λ, |xᵢ|, log T).

The starting point of our construction is the IVC for P construction of Devadas, Goyal, Kalai and Vaikuntanathan [FOCS '22] and Paneth and Pass [FOCS '22] via rate-1 batch arguments. We then show how to extend this construction to the setting of NP, and additionally modify it to achieve zero-knowledge. We avoid the Gentry-Wichs barrier via the use of subexponential assumptions and complexity leveraging.

According to aspects of the present disclosure, a method, system, and non-transitory computer-readable medium are provided for verifying the execution of any distributed computation C across multiple untrusted nodes starting from a configuration x₀, wherein each node computes from the previous configuration xᵢ the next configuration xᵢ₊₁ dependent on C and a nondeterministic input wᵢ. At a setup entity comprising at least one computerized processor and memory, security parameters ( [symbol] , T) are received via an electronic interface, where λ is a security parameter, and T is an iteration bound. The setup entity calculates [symbol] ₘₐₓ as a base-2 logarithm of T rounded up to the nearest integer as a representation of the maximum level of the proof hierarchy using the at least one processor. The setup entity generates a succinct non-interactive argument (SNARG) common reference string crs_{SNARG} for a language L_{SNARG} that contains all tuples (x₀, x₁) such that there exists a witness w such that C(x₀, w)=x₁. The setup entity generates a rate-1 somewhere extractable batch argument (seBARG) common reference string crs₁ for the language that contains all tuples (x₀, ⊥, x₁) for which there exists a SNARG proof π_{SNARG} that (x₀, x₁) is in L_{SNARG}. The setup entity generates a series of rate-1 somewhere extractable batch argument (seBARG) common reference strings [symbol] where for each level [symbol] , the seBARG is for the language that contains tuples (x₀, x₁, x₂) for which there exist (x_{L}, π_{L}) and (x_{R}, π_{R}) such that π_{L} is a previous level seBARG for (x₀, x_{L}, x₁) and TR is a previous level seBARG for (x₁, x_{R}, x₂). The generated reference strings are stored in the memory, and a combined common reference string crs:=(crs_{SNARG}, [symbol] ) is output via an electronic interface.

At a first prover entity comprising at least one computerized processor and memory and in electronic communication with the setup entity, the combined common reference string crs is received via an electronic interface. The first prover entity receives inputs x₀ and a witness w₀ via an electronic interface, computes a new state x₁=C(x₀, w₀) using the at least one processor, and generates a SNARG proof π_{SNARG} at level 0 using crs_{SNARG} for (x₀, x₁) with witness w₀ and outputs this as Π₁. The first prover entity transmits Π₁ to a subsequent prover entity via an electronic interface.

At a subsequent prover entity comprising at least one computerized processor and memory and in communication with both the setup entity and the first prover entity or a previous prover entity, the combined common reference string crs is received via an electronic interface. The subsequent prover entity receives inputs (x₀, xᵢ i), a proof Πᵢ, and a witness wᵢ via an electronic interface, and verifies Πᵢ is a proof for (x₀, xᵢ, i) using the same method as the verifier entity using the at least one processor. The subsequent prover entity computes a new state xᵢ₊₁=C(xᵢ, wᵢ) using the at least one processor and generates a SNARG proof π_{SNARG} at level 0 using crs_{SNARG} for (xᵢ, xᵢ₊₁). The subsequent prover entity merges proofs Πᵢ and π_{SNARG} to create a higher-level proof by repeating a process for all levels from 0 to [symbol] ₘₐₓ−1, where [symbol] ₘₐₓ is the maximum level of the proof hierarchy. This process includes checking if there are two proofs at level [symbol] and if not, continuing to the next level, verifying the adjacency of the two proofs by comparing end states and indices, computing a level 1 somewhere extractable batch argument (seBARG) proof that combines the two level 0 proofs using the seBARG merging algorithm with crs₁ for level 0 proofs, computing a seBARG proof at level [symbol] +1 that combines the two proofs using the seBARG merging algorithm with [symbol] including the intermediate state for proofs at level [symbol] greater than 1, and adding the newly created higher-level proof to the set of proofs at the next level. The merged proofs are stored in the memory and output as a new proof Πᵢ via an electronic interface.

At a verifier entity comprising at least one computerized processor and memory and in electronic communication with the prover entity, the combined common reference string crs is received via an electronic interface. The verifier entity receives inputs (x₀, xₜ, t) and a proof Πₜ via an electronic interface, verifies proofs at each level using the corresponding seBARG and SNARG verification algorithms using the at least one processor, and outputs a verification result via an electronic interface.

According to other aspects of the present disclosure, the method, system, and nontransitory computer-readable medium may include one or more of the following features. The succinct non-interactive argument (SNARG) common reference string crs_{SNARG} may be generated using a learning with errors (LWE) assumption with subexponential security parameter), a bilinear maps assumption with subexponential security parameter λ, or an indistinguishability obfuscation assumption with subexponential security parameter λ. The rate-1 somewhere extractable batch argument (seBARG) common reference strings [symbol] may be generated using a learning with errors (LWE) assumption with subexponential security parameter λ, a bilinear maps assumption with subexponential security parameter λ, or a discrete logarithm assumption with subexponential security parameter λ. Merging proofs at level [symbol] may comprise receiving a first proof π₁ for configurations ( [symbol] ) and a second proof π₂ for configurations ( [symbol] ), verifying that the endpoint configuration [symbol] matches between the two proofs, computing a level [symbol] +1 somewhere extractable batch argument proof [symbol] that combines π₁ and π₂ using the seBARG merging algorithm with [symbol] and outputting the merged proof [symbol] along with configurations xᵢ, [symbol] , and [symbol] .

According to another aspect of the present disclosure, a method, system, and nontransitory computer-readable medium are provided for verifying the execution of any distributed computation C across multiple untrusted nodes starting from a configuration x₀, wherein each node computes from the previous configuration xᵢ the next configuration xᵢ₊₁ dependent on C and a nondeterministic input wᵢ, additionally achieving zero knowledge for the witnesses used at each step of computation. At a setup entity comprising at least one computerized processor and memory, security parameters ( [symbol] , T) are received via an electronic interface, where λ is a security parameter, and T is an iteration bound. The setup entity calculates [symbol] ₘₐₓ as a base-2 logarithm of T rounded up to the nearest integer as a representation of the maximum level of the proof hierarchy using the at least one processor. The setup entity generates a succinct non-interactive argument (SNARG) common reference string crs_{SNARG} for a language L_{SNARG} that contains all tuples (x₀, x₁) such that there exists a witness w such that C(x₀, w)=x₁ using the at least one processor. The setup entity computes a public key and secret key pair (pk, sk) of a public key encryption (PKE) scheme using the at least one processor and computes a non-interactive zero knowledge (NIZK) common reference string crs_{NIZK} for a language L_{NIZK} that contains all tuples (ct₀, ct₁) for which there exist a tuple (x₀, x₁, r₀, r₁, T) such that ct_{b}=PKE.Enc(pk, x_{b}) with randomness r_{b} and π is a valid SNARG for (x₀, x₁). The setup entity generates a rate-1 somewhere extractable batch argument (seBARG) common reference string crs₁ for the language that contains all tuples (ct₀, ⊥, ct₁) for which there exists a NIZK proof π_{NIZK} that (ct₀, ct₁) is in L_{NIZK}. The setup entity generates a series of rate-1 somewhere extractable batch argument (seBARG) common reference strings [symbol] where for each level [symbol] , the seBARG is for the language that contains tuples (x₀, x₁, x₂) for which there exist (x_{L}, π_{L}) and (x_{R}, π_{R}) such that π_{L} is a previous level seBARG for (x₀, x_{L}, x₁) and π_{R} is a previous level seBARG for (x₁, x_{R}, x₂). The generated reference strings are stored in the memory, and a combined common reference string crs:=(pk, crs_{SNARG}, crs_{NIZK}, { [symbol] is output via an electronic interface.

At a first prover entity comprising at least one computerized processor and memory and in electronic communication with the setup entity, the combined common reference string crs is received via an electronic interface. The first prover entity receives inputs x₀ and a witness w₀ via an electronic interface, computes a new state x₁=C(x₀, w₀) using the at least one processor, and samples randomness r₀ and r₁ using the at least one processor. The first prover entity computes ct₀ as an encryption of x₀ under pk using randomness r₀, and computes ct₁ as an encryption of x₁ under pk using randomness r₁ using the at least one processor. The first prover entity generates a SNARG proof π_{SNARG} using crs_{SNARG} for (x₀, x₁) with witness w₀ using the at least one processor and generates a NIZK proof π_{NIZK} at level 0 of (ct₀, ct₁) using crs_{NIZK} and witness (x₀, x₁, r₀, r₁, π_{SNARG}). The generated proofs are stored in the memory, and (r₀, r₁, ct₀, ct₁, π_{NIZK}) is output as Π₁ via an electronic interface.

At a subsequent prover entity comprising at least one computerized processor and memory and in communication with both the setup entity and the first prover entity or a previous prover entity, the combined common reference string crs is received via an electronic interface. The subsequent prover entity receives inputs (x₀, xᵢ, i), a proof Πᵢ, and a witness un via an electronic interface, where Πᵢ is of the form (x₀, rᵢ, ct₀, ctᵢ, Sᵢ) where Si is a set of NIZK and seBARG proofs. The subsequent prover entity verifies Πᵢ is a proof for (x₀, xᵢ, i) using the same method as the verifier entity using the at least one processor, computes a new state xᵢ₊₁=C(xᵢ, wᵢ) using the at least one processor, and generates a SNARG proof π_{SNARG} using crs_{SNARG} for (xᵢ, xᵢ₊₁). The subsequent prover entity samples randomness rᵢ₊₁ using the at least one processor, computes ctᵢ₊₁ as an encryption of xᵢ₊₁ under pk using randomness xᵢ₊₁, and generates a NIZK proof π_{NIZK} at level 0 of (ctᵢ, ctᵢ₊₁) using crs_{NIZK} and witness (xᵢ, xᵢ₊₁, rᵢ, rᵢ, π_{SNARG}) where (ctᵢ, rᵢ) come from Πᵢ. The subsequent prover entity merges proofs Πᵢ and π_{NIZK} to create a higher-level proof by repeating a process for all levels from 0 to [symbol] ₘₐₓ−1, where [symbol] ₘₐₓ is the maximum level of the proof hierarchy. This process includes checking if there are two seBARG or NIZK proofs at level [symbol] in the proof set Sᵢ of Πᵢ and if not, continuing to the next level, verifying the adjacency of the two proofs by comparing end states and indices, computing a level 1 somewhere extractable batch argument (seBARG) proof that combines the two level 0 proofs using the seBARG merging algorithm with crs for level 0 proofs, computing a seBARG proof at level [symbol] +1 that combines the two proofs using the seBARG merging algorithm with crs [symbol] ₊₁ including the intermediate state for proofs at level [symbol] greater than 1, and adding the newly created higher-level proof to the set of proofs at the next level. The merged proofs are stored in the memory, and Πᵢ:=(r₀, rᵢ₊₁, ct₀, ctᵢ₊₁, Sᵢ₊₁) is output via an electronic interface, where Sᵢ₊₁ is the new set of merged seBARG and NIZK proofs at each level.

At a verifier entity comprising at least one computerized processor and memory and in electronic communication with the prover entity, the combined common reference string crs is received via an electronic interface. The verifier entity receives inputs (x₀, xₜ, t) and a proof Πₜ via an electronic interface, where Πₜ is of the form (r₀, rₜ, ct₀, ctₜ, Sₜ) where Sₜ is a set of NIZK and seBARG proofs. The verifier entity verifies ct₀ is an encryption of x₀ under pk using r₀ and ctₜ is an encryption of xₜ under pk using rₜ using the at least one processor, verifies proofs in St at each level using the corresponding NIZK and seBARG verification algorithms, and outputs a verification result via an electronic interface.

According to other aspects of the present disclosure, the method, system, and nontransitory computer-readable medium may include one or more of the following features. The succinct non-interactive argument (SNARG) common reference string crs_{SNARG} and the non-interactive zero knowledge (NIZK) common reference string crs_{NIZK} may be generated using a learning with errors (LWE) assumption with subexponential security parameter λ, a bilinear maps assumption with subexponential security parameter λ, or an indistinguishability obfuscation assumption with subexponential security parameter λ. The rate-1 somewhere extractable batch argument (seBARG) common reference strings [symbol] may be generated using a learning with errors (LWE) assumption with subexponential security parameter λ, a bilinear maps assumption with subexponential security parameter λ, or a discrete logarithm assumption with subexponential security parameter λ. Merging proofs at level [symbol] may comprise receiving a first proof π₁ for ciphertexts (ctᵢ, [symbol] and a second proof π₂ for ciphertexts ( [symbol] , [symbol] , verifying that the intermediate ciphertext [symbol] matches between the two proofs, computing a level [symbol] +1 somewhere extractable batch argument proof [symbol] that combines π₁ and π₂ using the seBARG merging algorithm with [symbol] , and outputting the merged proof [symbol] along with ciphertexts ctᵢ, [symbol] , and [symbol] .

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a hierarchical proof structure for incrementally verifiable computation, according to aspects of the present disclosure.

FIG. 2 illustrates a hierarchical proof structure for incrementally verifiable computation with multiple levels, according to aspects of the present disclosure.

FIG. 3 illustrates a block diagram of a hierarchical proof structure for incrementally verifiable computation, according to aspects of the present disclosure.

FIG. 4 illustrates a flowchart depicting a method for zero-knowledge distributed computation verification, according to aspects of the present disclosure.

FIG. 5 illustrates a flowchart depicting a method for distributed computation verification, according to aspects of the present disclosure.

FIG. 6 illustrates a block diagram of a First Prover Entity system for distributed computation verification, according to aspects of the present disclosure.

FIG. 7 illustrates a block diagram of a Setup Entity system for distributed computation verification, according to aspects of the present disclosure.

FIG. 8 illustrates a block diagram showing interconnected system architectures for distributed computation verification, according to aspects of the present disclosure.

FIG. 9 illustrates a block diagram of a Client Computing Architecture for distributed computation verification, according to aspects of the present disclosure.

FIG. 10 illustrates a server-client network architecture designed for distributed computation and data processing, according to aspects of the present disclosure.

### DETAILED DESCRIPTION

### 1 Introduction

On the Gentry-Wichs Barrier. The research community has viewed the impossibility result of Gentry and Wichs as presenting a formidable barrier to achieving IVC for NP computations. For instance, recent work which rules out IVC for NP in the random oracle model (under some additional assumptions) argues: “Since in particular the impossibility of Gentry-Wichs [GW11] for (adaptively sound) zk-SNARGs applies, one could not hope to construct non-deterministic IVC from “falsifiable assumptions”.” (See also similar language in prior work.) Indeed, note that even if we were to aim only for non-adaptively sound IVC for NP, where the configurations x₀ and x_{T} are chosen before the common reference string is published, this does not avoid the problem that the intermediate states x₁, . . . , x_{T-1} can still be chosen adaptively after the CRS is published. As a result, some degree of adaptive soundness seems inherent in IVC for NP.

In this work, we address and circumvent this barrier head-on, as we explain further in Section 2.2, and we achieve full adaptively sound IVC for NP. Interestingly, our circumvention of the Gentry-Wichs barrier is different in spirit from the recent line of works on adaptive SNARGs for NP from iO.

### 1.1 Results

In this work, we construct zero-knowledge IVC for NP in the common reference string model from standard assumptions where the proof size, update time and verification time only grow polylogarithmically in the number of steps T.

Theorem 1.1. Consider an IVC language corresponding to machine [symbol] which takes as input a configuration of length n: =n(λ) and witness of length m: =m(λ), and outputs another configuration of length n. Assume the existence of the following ingredients:
(Non-adaptive) succinct non-interactive arguments (SNARG) for NP with proof size [symbol] (λ)≤m(λ).
Rate-1 somewhere extractable batch arguments for NP.
Statistically sound non-interactive zero knowledge proofs (NIZK) for NP.
   Then, there exists a zero-knowledge IVC scheme for NP with proof size of poly(n, [symbol] , log T, λ) where T is an upper bound on the number of time-steps of the IVC scheme.

Our construction follows prior approaches, who show how to build IVC for P via rate-1 BARGs. Note that statistically sound NIZKs can be built from LWE or bilinear maps. Moreover, rate-1 somewhere extractable BARGs can be instantiated from LWE, or from bilinear maps, assuming prior work. Therefore, by first plugging in “trivial” SNARG where the proof is simply the witness (i.e. [symbol] (λ)=m(λ)), we have the following corollary.

Corollary 1.2. Assuming either subexponential LWE or subexponential bilinear maps, there exists a zero-knowledge IVC scheme for NP with proof size poly(n, m, log T, λ).

At first glance, this result might seem surprising because of our earlier observation that IVC for NP seems to imply SNARGs for NP. How did we build IVC from assumptions that we did not know how to build SNARGs for NP? However, taking a closer look at the parameters that we achieve, when T=O(1), the proof size is poly(n, m, log T, λ), i.e. the proof grows with a witness. Since a SNARG for NP is a special case of “onehop” IVC for NP, we do not achieve succinctness in this special case. If we additionally demand that the proof size does not grow polynomially with the size of the witness m, then we would in fact achieve a SNARG with mild succinctness—one whose proof size grows polynomially with the size of the statements n, but only polylogarithmically in m. Such SNARGs are not known from LWE or bilinear maps. Therefore, to obtain our second corollary, we rely on the existence of i [symbol] and plug in the Sahai-Waters SNARG.

Corollary 1.3. Assuming subexponential i [symbol] , and either subexponential LWE or subexponential bilinear maps, there exists a IVC scheme for NP with proof size poly(n, log m, log T, λ).

Note that the proof size only grows polylogarithmically with time bound T and witness size m, but grows polynomially with the configuration size n. This matches the succinctness achieved in the IVC of P setting (Although we suspect for the setting of P, it might be possible to improve the dependence on n to polylogarithmic. Prior works do not optimize this as far as we are aware.). As a side note, while i [symbol] as is, is not considered to be a standard falsifiable assumption, there are known constructions of i [symbol] from standard assumptions. Therefore, we in turn achieve an IVC for NP scheme from standard assumptions. Thus, the main problem left open after our work is to achieve succinctness with respect to n. That is, can we achieve IVC for NP with proof size poly(λ, log n, log m, log T)?

### 1.2 Organization of the Paper

In Section 2, we give a technical overview of our work. In particular, we go over existing works, our construction and outline our proof of security. In Section 3, we introduce relevant notation and definitions. In Section 4.2, we present our construction and analyze the parameters of the scheme.

### 2 Technical Overview

In this section, we give an overview of our construction of IVC for NP. As a starting point, we will first review existing constructions for the simpler problem of constructing IVC for P from standard assumptions. We will then describe our ideas for constructing IVC for NP. Finally, we show how to modify this construction to additionally achieve a zero-knowledge property.

### 2.1 Prior Work

Valiant's IVC template. In his seminal work that defined IVC, Valiant also proposed the following construction for IVC via “proof merging” assuming the existence of a “computational” proof of knowledge (i.e. a SNARK). The high level idea is as follows: Given a SNARK proof π₁ that x₁ reaches x₂ after t₁ (deterministic) steps, and a proof π₂ that x₂ reaches x₂ in t₂, one can “merge” π₁ and π₂ to obtain a proof π that x₁ reaches x₂ in t₁+t₂ steps. If the merged proof π has length roughly equal to one of π₁ and π₂, one can repeatedly merge proofs to obtain an IVC construction. To argue soundness, one would require use the knowledge soundness of π to recursively extract the merged proofs π₁ and π₂.

While this template has been utilized in several works to construct IVC (and more generally, proof carrying data), there are known barriers to constructing SNARKs for all of NP from falsifiable assumptions. Therefore, we need a different approach in order to construct IVC for P (and NP) from standard assumptions.

Somewhere extractable BARGs. This template was adapted to the setting of IVC for P in the works of Devadas et al. and Paneth and Pass to rely only on rate-1 somewhere extractable batch arguments (seBARGs).

Recall that a BARG is a SNARG for Batch-NP-languages, i.e. languages of the form:
{x₁, . . . , xₖ)|∃(w₁, . . . , wₖ) such that R(xᵢ, wᵢ)=1 for all i}.
   A somewhere extractable BARG or seBARG has the following properties.
Somewhere extractability: Given an index i, one can generate a crs along with a trapdoor to such that given a proof a corresponding to (x₁, . . . , xₖ), one can extract a witness wᵢ←Ext(crs, td, π).
Index hiding: Given only the crs, the index i on which it is somewhere-sound is hidden.

The succinctness requirement for a BARG proof π for k instances is that |π|<<k·|w|. Since the succinctness requirement and the knowledge soundness property for a seBARG is milder than that of a full fletched SNARK for NP, seBARGs can in fact be constructed from various falsifiable assumptions, including LWE. Moreover, prior works show how to achieve rate-1 BARGs, where the proof length is |π|=|w|+poly(λ). Note that this is the best succinctness one can hope for while maintaining the somewhere extractability property.

From Rate-1 BARGs to IVC for P. The observation in prior works is that the knowledge soundness achieved by seBARGs is sufficient for the “merging” step in Valiant's template. Moreover, the fact that the seBARG is rate-1 is crucial in ensuring that the proof size does not grow.

We now give a sketch of the IVC for P construction from prior work from rate-1 seBARGs. We say xₜ←next-config_{M}(x₀, t) if xₜ is the configuration obtained from running the Turing machine M on configuration x₀ for t steps. We describe the construction following the exposition of Paneth and Pass.

At a high level, they aggregate the proofs in a tree structure.
Base case: For a single time step x₀→x₁ such that next-config_{M}(x₀, 1)=x₁, compute a RAM delegation proof (We will not go into the details of what a RAM delegation proof is, but we refer the reader to prior work for the definition, and another work for a construction from BARGs.) π with respect to hashes (These need to be somewhere statistically binding hashes, but this detail is not important for this exposition.) h₀=Hash (x₀) and h₁=Hash (x₁) of the corresponding configurations. The soundness guarantee of the RAM delegation proof ensures that no efficient adversary can come up with x₀, x₁, h₀,

$${h}_{1}^{′}$$

π such that IVC.

$${Ver}_{0} ( {h}_{0} , {h}_{1}^{′} , π ) = 1 ,$$

x₁=next-config_{M}(x₀, 1), and h₀=Hash(x₀), but

$${h}_{1}^{′} \neq$$

Hash(x₁). We call this a “level 0” proof.
Merging proofs at level k+1: Suppose we have two “level k” proofs:
   (h₀, h₁, π0) is proof that configuration x₀ reaches x₂_{^{k}} in 2^{k} steps satisfying h₀=Hash(x₀), h₁=Hash(x₂_{^{k}}) and IVC. Verₖ(h₀, h₁, π₀)=1.
   (

$${h}_{1}^{′}$$

h₂, π₁) is proof that configuration

$${x}_{{2}^{k}}^{′}$$

reaches r₂_{^{k+1}} in 2^{k} steps satisfying

$${h}_{1}^{′} = Hash ( {x}_{{2}^{k}}^{′} ) ,$$

h₂=Hash(x₂_{^{k+1}}) and IVC.

$${Ver}_{k} ( {h}_{1}^{′} , {h}_{2} , {π}_{1} , k ) = 1 .$$

To merge them to form a proof that x₀ reaches x₂_{^{k+1}} in 2^{k+1} steps, we first require that

$${x}_{{2}^{k}} = {x}_{{2}^{k}}^{′} ,$$

i.e. the endpoints of the two proofs are consistent. Then, we create a “level k+1” proof via a rate-1 seBARG proof π_{BARG} on the statements (h₀, h₁), and (h₁, h₂) proving that there exists π₀ and π₁ such that IVC. Verₖ(h₀, h₁, π₀)=1 and IVC. Verₖ(h₀, h₁, π₀)=1, and define

$$IVC . {Ver}_{k + 1} ( {h}_{0} , {h}_{2} , ( {h}_{1} , {π}_{B A R G} ) ) = seBARG . 𝒱 ( ( ( {h}_{0} , {h}_{1} ) , ( {h}_{1} , {h}_{2} ) ) , {π}_{B A R G} ) .$$

The size of the new proof is π=(h₁, π_{BARG}) has length |h₁|+|π_{BARG}|=|h₁|+|π₀|+poly(λ)≤|π₀|+poly(λ). Hence, the merged proof is not much larger than the size of a single proof.

Soundness for IVC for P. At a high level, Paneth and Pass establish the soundness of a “level k” proof as follows. Suppose there exists an adversary [symbol] that creates cheating level k proofs with probability ∈. In other words, he produces configurations x₀, x₂_{^{k}}, h₀, h₂, (h₁, π_{BARG}) such that x₂_{^{k}}≠next-config(x₀, 2^{k}). Let x′←next-config(x₀, 2^{k-1}).
If h₁≠Hash(x′), then we say that [symbol] cheats on hop 0.
Else, it must be the case that next-config(x′, 2^{k-1})≠x₂_{^{k}} and we say [symbol] cheats on hop 1.

Suppose that [symbol] cheats on hop 0 with probability

$$\frac{ϵ}{2} .$$

Now, switch the seBARG crs to one that is extracting on hop 0. Then, there are two possible cases:
[symbol] cheats on hop b with probability at least ∈/2. Extract the level k−1 proof from the seBARG corresponding to hop b. Now, one can allude to the soundness of the level k−1 proof inductively. Ultimately, one can extract a cheating level 0 proof with probability ∈/T.
   [symbol] cheats on hop b with probability less than ∈/2. Note that in this case, we can use [symbol] to break the index-hiding property of the seBARG. To be able to check that [symbol] cheats on hop b, it is crucial that the reduction is able to decide if [symbol] is outputting cheating instances (x₀, x₂_{^{k}}), i.e. x₂_{^{k}}≠next-config(x₀, 2^{k}). Since this can be decided in time roughly poly(|x₀|, T) where T is the bound on the runtime of the TM.

Therefore, one can then inductively argue that level k proofs are sound.

### 2.2 Our Construction

We now motivate our construction for IVC for NP.

The challenge in achieving IVC for NP. One of the key properties required in the soundness analysis of prior work was that the reduction can decide given a tuple (x₀, xₜ, t), if xₜ was in fact reachable from x₀ in t steps. This allowed one to be able to switch where the seBARG was extracting, in order to recursively extract a false level 0 proof. In the case when this transition was deterministic (i.e. in P), this can be decided in time poly(|x|, t)≤poly(|x|, T), where T was an upper bound on the number of steps. However, if the computation path takes non-deterministic steps, the witness from x₀ to xₜ has length |w|·t, and a brute-force search overall all such witness will take time 2^{O(|w|·T)}. If our reduction has to be 2^{O(|w|·T)}-secure, it seems like the combined crs and proof length has to be at least poly(|w|·T). This efficiency can be trivially achieved by simply maintaining all the intermediate witnesses. Therefore, it seems like IVC for NP with non-trivial succinctness is out of reach from standard assumptions.

Overcoming Gentry-Wichs. This informal argument that the reduction needs to “decide” the language was in fact formalized by Gentry-Wichs for the case of SNARGs. Since IVC in particular implies a SNARGs for the corresponding language, Gentry-Wichs has been often quoted as a reason why IVC for NP from standard assumptions is in fact impossible.

However, our observation is that the special IVC language defined by

$${ℒ}_{M , T} = \{ ( {x}_{0} , {x}_{t} , t ) : \begin{matrix}M : {\{ 0 , 1 \}}^{n} \times {\{ 0 , 1 \}}^{m} \to {\{ 0 , 1 \}}^{m} , {x}_{0} , {x}_{t} ∈ {\{ 0 , 1 \}}^{n} , t \leq T , \\ \begin{matrix}∃ ( {x}_{1} … , {x}_{t - 1} , {w}_{1} , … , {w}_{t} ) such that \\ ∀ i ∈ [ t ] , M ( {x}_{i} , {w}_{i} ) = {x}_{i + 1}\end{matrix}\end{matrix} \}$$

has a non-uniform circuit of size 2^{O(|x|)}·poly(T) which decides the language: the circuit that hardcodes the whole truth-table of the [symbol] _{M,T}. Therefore, it is in fact sufficient to rely on 2^{O(|x|)}·poly(T, λ)-hardness of the underlying assumptions. (This technique is also known as complexity-leveraging.) Assuming subexponential hardness, we can then hope to achieve proofs of size poly(λ, |x|, log T). While this proof size still grows with the size of each configuration, it does not grow polynomially in T! Therefore, there still seems to be room to achieve a non-trivial proof length, and this is in fact what we leverage.

Main modifications. We now highlight the main modifications that we make relative to the IVC for P construction.
Instead of using RAM delegation proofs to prove Hash (xᵢ₋₁) goes to Hash (xᵢ) at level 0, we instead use adaptive SNARGs for NP to prove that there exists wᵢ so that xᵢ₋₁ [symbol] xᵢ.
Next, we no longer hash the intermediate configurations, and instead maintain the “midpoint” configuration as is when merging proofs.
We rely on 2^{O(|x|)}·poly(T, λ) hardness of underlying assumptions.

Detailed construction. Here, we describe our construction in detail (see Section 4.2 for a formal description of the algorithm). For simplicity, we present here a version of the construction that does not achieve zero-knowledge. However, we discuss the modifications needed to achieve zero knowledge in Section 2.3.

Our main ingredients (We additionally rely on public key encryption and NIZKs to make our construction zero-knowledge, but we will defer that discussion to Section 2.3) for our constructions are as follows:
2^{O(|x|)}·poly(T, λ)-sound non-adaptive SNARG for NP. Intuitively, we will use this to create the level 0 proofs.
2^{O(|x|)}·poly(T, λ)-sound rate-1 somewhere-extractable arguments for Batch-NP (seBARGs). Note that although the BARG is rate-1, the proof size will incur an additive poly(λ, |x|, log T) term since we require 2^{O(|x|)}·poly(T, λ)-security.

Remark 2.1. For simplicity of exposition in this technical overview, we use the terminology 2^{λ}^{^{δ}}-security of an assumption mean that all adversaries of size at most 2^{λ}^{^{δ}} have advantage at most 2^{-λ}^{^{δ}}. In our actual construction, it suffices to consider poly(λ)-adversaries with advantage at most 2^{-λ}^{^{δ}}.

Step 1. Suppose the starting configuration is x₀, and the prover uses the witness un to go from x₀ to state x₁. Then, the prover computes a SNARG proof

$${π}_{1}^{( 0 )}$$

that there exists a witness w₁ such that C(x₀, w₁)=x₁.

Output the starting configuration x₀, the final configuration x₁, time step t=1, and a level 0 proof

$${Π}^{( 0 )} = ( {x}_{0} , {x}_{1} , {π}_{1}^{( 0 )} ) .$$

Invariant at Step i. At step i, an honest prover outputs the following:
Starting configuration: x₀
i^{th} configuration: xᵢ
Let [symbol] =└log₂ i┘, and let i= [symbol] be the bit decomposition of i, i.e. i=

$${\sum }_{j = 0}^{ℓ} {b}_{j} \cdot {2}^{j} .$$

For all j such that bⱼ=0, we have Π^{(j)}=Ø. For all j such that bⱼ=1:
   For j=0, Π^{(j)} contains two states xₖ and xₖ₊₁ for some k, and a SNARG proof

$${π}_{k + 1}^{( 0 )} .$$

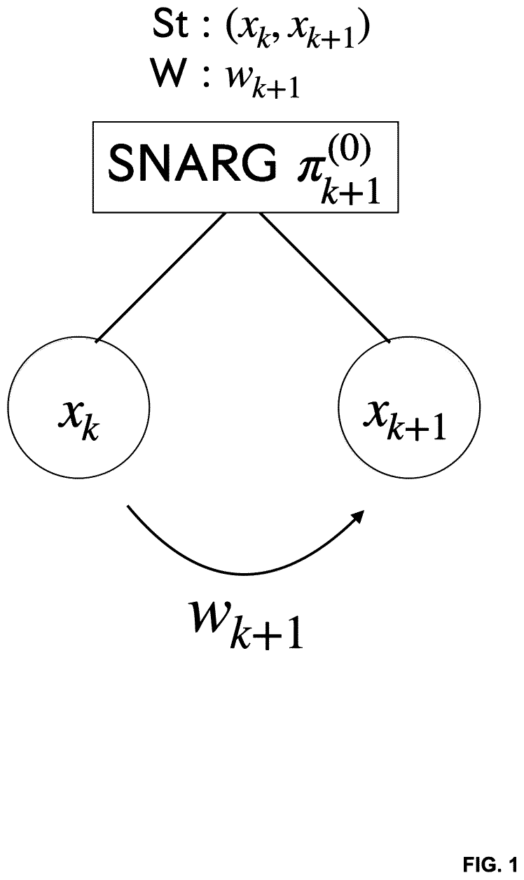

This is depicted in FIG. 1.
For j=1, Πⱼ contains three states xₖ, xₖ₊₁, xₖ₊₂ for some k, and a “level 1” seBARG proof

$${π}_{( k + 2 ) / 2}^{( 1 )}$$

that fact that were exist level 0 SNARG proofs

$${π}_{k + 1}^{( 0 )}$$

and

$${π}_{k + 1}^{( 1 )}$$

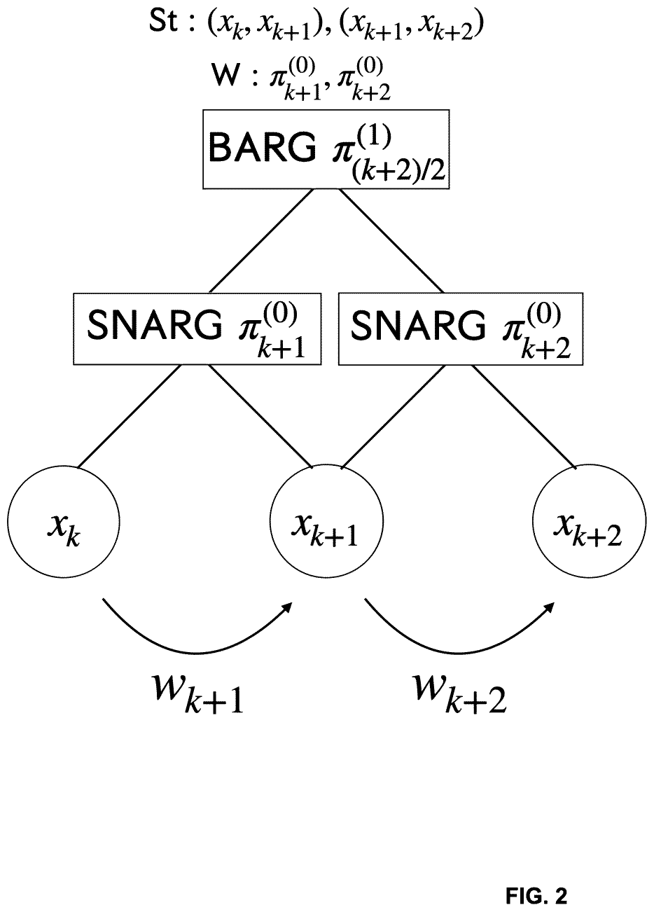

for the statements (xₖ, xₖ₊₁) and (xₖ₊₁, xₖ₊₂). This is depicted in FIG. 2.
For j≥2, Π^{(j)} contains three states xₖ, xₖ₊₂_{^{j−1}}, xₖ₊₂_{^{j}} for some k (which for ease of notation we shall refer to as xᵢₙᵢₜ, x_{mid}, x_{fin}) and a seBARG proof of the fact that:
   For statement (xᵢₙᵢₜ, x_{mid}): there exists [symbol] _{L} and π^{(j-1)} such that the level j−1 seBARG would accept the proof

$${π}_{L}^{( j - 1 )}$$

for the statements (xᵢₙᵢₜ, [symbol] ) and ( [symbol] _{L}, x_{mid}).
For statement (x_{mid}, x_{fin}): there exists [symbol] _{R} and

$${π}_{R}^{( j - 1 )}$$

such that level j−1 seBARG would accept the proof

$${π}_{R}^{( j - 1 )}$$

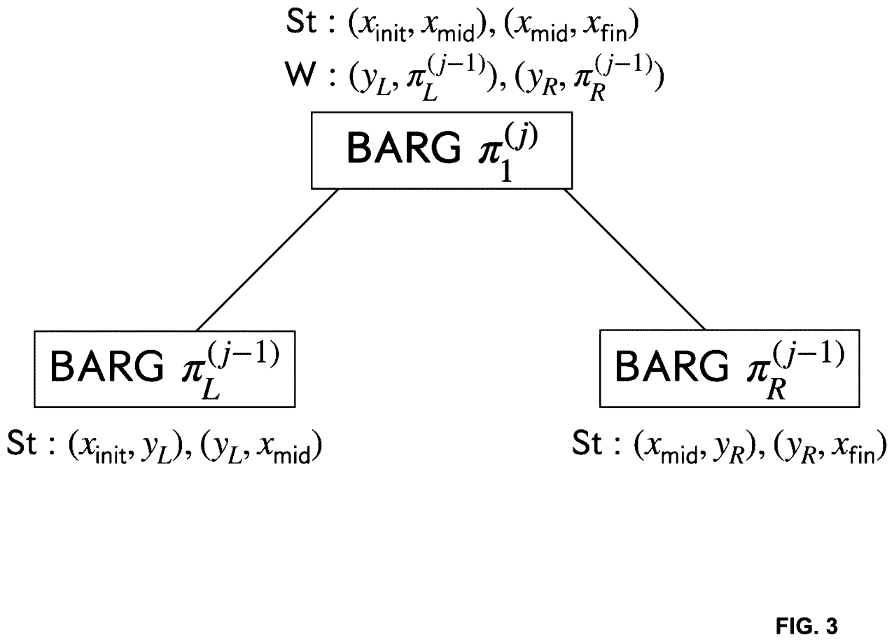

for the statements (x_{mid}, [symbol] _{R}) and ( [symbol] _{R}, x_{fin}).
(We have labeled the proofs and witness via L and R for readability—one can compute the exact indexing). This is depicted in FIG. 3.

Step i+1. At the start of this level, we are given the starting configuration x₀, the ith configuration xᵢ, and proofs Π⁽⁰⁾, Π⁽¹⁾, . . . , [symbol] where [symbol] =└log₂ i┘.

Suppose the prover uses a new witness with to go from configuration xᵢ to xᵢ₊₁. First, she creates a level 0 SNARG proof,

$${π}_{i}^{( 0 )} .$$

### Add

$$( {x}_{i} , {x}_{i + 1} , {π}_{i}^{0 )} )$$

to Π⁽⁰⁾. If Π⁽⁰⁾ contains two proofs, we do the following: for j=0, 1, . . . , [symbol] ,
If Π^{(j)} has two level j proofs, remove the two proofs, and “merge” them into a level j+1 proof.
Add the proof to Π^{(j+1)}. (Note that this might create a new level [symbol] if i+1 is a power of 2.)

Efficiency. After t steps, note that the proof comprises [symbol] =[log t] proofs Π⁽⁰⁾, . . . , [symbol] , where Π⁽ⁱ⁾ contains a level i seBARG proof and 3 states. Hence, |Π⁽ⁱ⁾|=3|x|+|π⁽ⁱ⁾|.

Let [symbol] ᵢ denote a bound on the length a level i proof.

Recall that level 0 proofs are SNARGs, [symbol] ₀≤poly(|x|, log T, λ) at the base level. Since level 1 proofs are a rate-1 seBARG proof where the witness is a level 0 proof, we have

$${ℓ}_{1} \leq {ℓ}_{0} + poly ( \vert x \vert , log T , λ ) .$$

For j≥2, each level j proof is a rate-1 seBARG proof where the witness is a level 0 along with three states, and hence

$$\begin{matrix}{ℓ}_{j} \leq {ℓ}_{j - 1} + 3 \vert x \vert + poly ( \vert x \vert , log T , λ ) \\ \leq O ( j ) \cdot \vert x \vert + j \cdot poly ( \vert x \vert , log T , λ ) \\ \leq poly ( \vert x \vert , log T , λ ) .\end{matrix}$$

It is then easy to see that step i takes poly(|x|, log T, λ) time because there are at most log t proofs, each of length poly(|x|, log T, λ).

For a detailed analysis, see Section 4.1.

Proving soundness. Level 0 proofs are sound by the soundness of the underlying SNARG.

Suppose there exists an adversary [symbol] which creates cheating level j proofs with probability

$$ϵ \geq \frac{1}{poly ( λ )} .$$

Suppose (xᵢₙᵢₜ, x_{mid}, x_{fin}, π^{(j)})← [symbol] (IVC.crs), where (xᵢₙᵢₜ, x_{fin}, 2^{j})∉ [symbol] _{M,T} although π^{(j)} accepts with probability ∈/2. Without loss of generality, suppose that [symbol] creates accepting proofs π^{(j)} with (xᵢₙᵢₜ, x_{mid}, 2^{j-1})∉ [symbol] _{M,T} probability at least ∈/2. Now, set the seBARG to be extracting on the first instance (xᵢₙᵢₜ, x_{mid}). As in the case for IVC for P, we can argue a case analysis as follows:
[symbol] still creates accepting proofs corresponding to (xᵢₙᵢₜ, x_{mid}, 2^{j-1})∉ [symbol] _{M,T} with probability at least ∈/2. By the somewhere extractability of the seBARG, one can extract an accepting level j−1 proof ( [symbol] , π^{(j)}). Now, we can recursively appeal to the soundness of the level j−1 proof. Since j≤log T, the ½ loss per level only compounds to a factor of at most 1/T. Therefore, this would give an adversary that has a

$$\frac{1}{poly ( λ ) \cdot T}$$

advantage on the underlying SNARG.
[symbol] produces accepting proofs corresponding to (xᵢₙᵢₜ, x_{mid}, 2^{j-1})∉ [symbol] _{M,T} with probability noticeably smaller than ∈/2. In this case, since the reduction has the truth-table hard-coded in it, it can detect this change and use this to distinguish the 2^{O(|x|)}·poly(T, λ)-secure index-hiding property of the seBARG.

### 2.3 Adding Zero-Knowledge

Now, we describe how we modify our scheme additionally to achieve zero knowledge.

A first attempt. As a first step, one can imagine simply replacing the rate-1 seBARG and SNARG with ones that are zero-knowledge. However, this does not quite work because the zero-knowledge property only guarantees that the witness is hidden, not the statements.

As an illustrative example, consider a proof for a computation of 2^{j} steps for the starting configuration xᵢₙᵢₜ:=x₀, the final configuration x_{fin}:=x₂_{^{j}}. Ideally, one can argue that the IVC proof reveals nothing about the path from xᵢₙᵢₜ to x_{fin}. Looking back at our construction, the corresponding IVC proof contains a level j proof Π^{(j)} (since t is a power of 2). Note that Π^{(j)} not only contains a seBARG proof π^{(j)}, but also 3 states xᵢₙᵢₜ, x_{mid}, x_{fin} where x_{mid} is the “midpoint” (i.e. x₂_{^{j−1}}), which leaks information about the path used to reach x_{fin} from xᵢₙᵢₜ. Even if the seBARG proof is zero-knowledge, x_{mid} is given out in the clear. We therefore have to find a way to hide the intermediate states.

Our solution. To achieve our construction, we instead rely on the following additional tools:
Statistically sound non-interactive zero knowledge argument (NIZK), which is additionally a proof of knowledge.
Public-key encryption scheme with perfect correctness.

Now, along with the SNARG and BARG common reference strings, a single NIZK crs and the public key pk are published. Now, we highlight the main differences:
All configurations xᵢ are encrypted under pk. We denote by ctᵢ the encryption of xᵢ, and let rᵢ be the corresponding randomness.
At step i+1, only the randomness r₀ and rᵢ used in the encryptions of x₀ and xᵢ are given in the clear (note that one can verify the given randomness matches the ciphertext by simply encrypting and checking equality). After the step, the randomness rᵢ is tossed and only the randomness rᵢ₊₁ used to encrypt xᵢ₊₁ is maintained.
A level 0 proof at step i+1 for xᵢ [symbol] xᵢ₊₁ is now constructed as follows:
   Sample randomness rᵢ₊₁ and encrypt xᵢ₊₁ to obtain ctᵢ₊₁.
   Create a SNARG proof π_{SNARG} for the fact that there exists a witness wᵢ₊₁ such that M(xᵢ, wᵢ₊₁)=xᵢ₊₁.
   Create a NIZK proof π_{NIZK} for the instance (ctᵢ, ctᵢ₊₁) proving that there exist xᵢ, xᵢ₊₁, rᵢ, rᵢ₊₁, π_{SNARG} such that:

$${Enc}_{pk} ( {x}_{i} , {r}_{i} ) = {ct}_{i} \\ {Enc}_{pk} ( {x}_{i + 1} , {r}_{i + 1} ) = {ct}_{i + 1} \\ SNARG . 𝒱 ( {x}_{i} , {x}_{i + 1} , {π}_{SNARG} ) = 1$$

The new level 0 proof comprises (ctᵢ, ctᵢ₊₁, π_{NIZK}).
Level 1 seBARG proofs for statements (ctₖ, ctₖ₊₁) and (ctₖ₊₁, ctₖ₊₂) now instead prove that there exists

$${π}_{L}^{( 0 )} and {π}_{R}^{( 1 )}$$

such that

$$NIZK . 𝒱 ( {ct}_{k} , {ct}_{k + 1} , {π}_{L}^{( 0 )} ) = 1 \\ NIZK . 𝒱 ( {ct}_{k + 1} , {ct}_{k + 2} , {π}_{R}^{( 0 )} ) = 1$$

Level j proofs for j≥2 are constructed just as before with respect to level j−1 proofs, except the statements are defined by the ciphertexts ctₖ, ctₖ₊₂_{^{j−1}}, ctₖ₊₂_{^{j}} rather than their corresponding configurations xₖ, xₖ₊₂_{^{j−1}}, xₖ₊₂_{^{j}}.

It suffices to check the soundness of the level 0 proofs since the rest of the construction is essentially identical. Since NIZK is statistically sound and is a proof of knowledge, the only possible way to create a cheating level 0 proof is if SNARG. [symbol] (xᵢ, xᵢ₊₁, π_{SNARG})=1 even though xᵢ [symbol] xᵢ₊₁. In this case, we have extracted a cheating SNARG proof, thereby reaching a contradiction.

Sketch of zero-knowledge. We sketch a sequence of hybrids to show that an IVC proof Π=(ct₀, ctᵢ, r₀, rᵢ, Π⁽⁰⁾, Π⁽¹⁾, . . . , [symbol] ) for the statement (x₀, xᵢ, i) is zero-knowledge, i.e. can be simulated given only (x₀, xᵢ, i).
[symbol] ₀: Sample the common reference string, and construct the proof as an honest prover would based on an honest sequence x₀ [symbol] x₁ [symbol] . . . [symbol] xᵢ.
[symbol] ₁: Compute the ciphertext ctᵢ←Encₚₖ(xᵢ, rᵢ) honestly, but simulate the NIZK crs and all level 0 NIZK proofs using the zero-knowledge simulator for NIZK. Compute all level j proofs as before for j≥1.

Indistinguishability follows from the zero-knowledge simulation security of the NIZK.
[symbol] ₂: Sample randomness r₀ and rᵢ. Compute ct₀=Encₚₖ(x₀; r₀) and ctᵢ=Encₚₖ(xᵢ; rᵢ), but replace ctₖ←EnCₚₖ(0) for all 1≤k≤i−1. Construct the rest of the proof as in [symbol] ₁.
   Note that the randomness used to sample the ciphertexts ctₖ for 1<k≤i−1 are hidden from the view in both [symbol] ₁ and [symbol] ₂. Therefore, indistinguishability follows from the semantic of the public-key encryption scheme.

Note that everything in [symbol] ₂ can be simulated given only x₀ and xᵢ. Therefore, [symbol] ₂ defines a zero-knowledge simulator for the modified IVC protocol, as desired.

### 3 Preliminaries

Throughout, we will use λ to denote the security parameter.
We say that a function ƒ(λ) is negligible in λ if ƒ(λ)=λ^{-w(1)}, and we denote it by ƒ(λ)=negl(λ).
We say that a function g(λ) is polynomial in λ if g(λ)=p(λ) for some fixed polynomial p, and we denote it by g(λ)=poly(λ).
For n∈ [symbol] , we use [n] to denote {1, . . . , n}.
If R is a random variable, then r←R denotes sampling r from R. If T is a set, then i←T denotes sampling i uniformly at random from T.

Security Notions. We will use the parameters (s, ∈) to describe the security parameters of our primitive. In particular, we say that a primitive is (s, ∈)-secure if for all sufficiently large λ and all adversaries [symbol] of size s(λ), the advantage of [symbol] is ∈(λ).
Polynomial Security: We say that a primitive is polynomially secure if it is (s, negl(λ))-secure for all polynomials s=s(λ).
Sub-exponential Security: We say that a primitive is sub-exponentially secure (Note that in some settings, sub-exponential security refers to the case where the primitive is (2^{λc}, 2^{-λc})-secure for some 0<c<1. We do not need this stronger notion in our work.) if it is (s, 2^{-λc})-secure for some 0<c<1 and for all polynomials s=s(λ).

### 3.1 Incrementally Verifiable Computation (IVC)

Definition 3.1 (IVC Language). We define the IVC language [symbol] _{IVC} to be

$${ℒ}_{IVC} = \{ ( 𝒞 , {x}_{0} , {x}_{t} , t ) : \begin{matrix}C : {\{ 0 , 1 \}}^{n} \times {\{ 0 , 1 \}}^{m} \to {\{ 0 , 1 \}}^{n} , {x}_{0} , {x}_{t} ∈ {\{ 0 , 1 \}}^{n} \\ ∃ ( {x}_{1} … , {x}_{t - 1} , {w}_{1} , … , {w}_{t} ) such that ∀ i ∈ [ t ] , 𝒞 ( {x}_{i} , {w}_{i} ) = {x}_{i + 1}\end{matrix} \}$$

We define [symbol] _{C,i} to be the restriction of [symbol] _{IVC} to iteration bound t=i and circuit C═C, i.e.

$${ℒ}_{C , i} = \{ ( {x}_{0} , {x}_{i} ) : ( C , {x}_{0} , {x}_{i} , i ) ∈ {ℒ}_{IVC} \}$$

Definition 3.2 (IVC for [symbol] _{IVC} (adapted from prior work)). An incrementally verifiable computation (IVC) scheme for [symbol] _{IVC} is a tuple of PPT algorithms IVC=(IVC.Gen, IVC. [symbol] , IVC. [symbol] ) where.
IVC.Gen(1^{λ}, T, 1ⁿ, 1^{m}, C): takes as input the security parameter λ, an iteration bound T in binary, an input length n, a witness length m, and a circuit C: {0, 1}ⁿ×{0, 1}^{m}→{0, 1}ⁿ, and outputs a common reference strings crs.
IVC. [symbol] (crs, (x₀, xᵢ₋₁, x−1), πᵢ₋₁, wᵢ): takes as input the common reference string crs, inputs x₀, xᵢ₋₁∈{0, 1}ⁿ, an index i−1∈[T−1], a proof πᵢ₋₁, and a witness wᵢ∈{0, 1}^{m}, and outputs a proof πᵢ.
IVC. [symbol] (crs, (x₀, xₜ, t), πₜ): takes as input the common reference string crs, inputs x₀, xₜ∈{0, 1}ⁿ, an index i∈[T], and a proof πₜ, and outputs a value in {0, 1}.

The scheme is additionally required to satisfy completeness and efficiency as defined below.

Completeness: For all λ∈ [symbol] , all iteration bounds T≤2^{λ}, all t≤T, all polynomials n=n(λ), m=m(λ), all polynomial-sized circuits C:{0, 1}ⁿ×{0, 1}^{m}→{0, 1}ⁿ, all x₀∈{0, 1}ⁿ, and all w₁, . . . , wₜ∈{0, 1}^{m},

$$Pr [ IVC . 𝒱 ( crs , ( {x}_{0} , {x}_{t} , t ) , {π}_{t} ) = 1 : \begin{matrix}crs ← IVC . Gen ( {1}^{λ} , T , {1}^{n} , {1}^{m} , C ) \\ ∀ i ∈ [ t ] : {x}_{i} = C ( {x}_{i - 1} , {w}_{i} ) \\ ∀ i ∈ [ t ] : \\ {π}_{i} \to IVC . 𝒫 ( crs , ( {x}_{0} , {x}_{i - 1} , i - 1 ) , {π}_{i - 1} , {w}_{i} )\end{matrix} ] = 1.$$

Efficiency: There exists polynomials p₁ and p₂ such that on setup parameters (1^{λ}, T, 1ⁿ, 1^{m}, C) where C is a polynomial-sized circuit C: {0, 1}ⁿ×{0, 1}^{m}→{0, 1}ⁿ, all algorithms run in time p₁(λ, log T, |C|) and the proof size is p₂(λ, n, m, log T, log |C|).

We say that the scheme satisfies (adaptive) (s, ∈)-soundness if the following holds:
(s, ∈)-Soundness: For all sufficiently large λ, for all polynomial-sized circuits C, all s=s(λ) sized adversaries [symbol] , and all T≤2^{λ},

$$Pr [ \begin{matrix}IVC . 𝒱 ( crs , ( {x}_{0} , {x}_{t} , t ) , {π}_{t} ) = 1 \\ ( C , {x}_{0} , {x}_{t} , t ) ∉ {ℒ}_{IVC}\end{matrix} : \begin{matrix}crs ← IVC . Gen ( {1}^{λ} , T , {1}^{n} , {1}^{m} , C ) \\ ( {x}_{0} , {x}_{t} , {1}^{t} ) ← 𝒜 ( crs , st )\end{matrix} ] \leq ϵ ( λ )$$

Additionally, we say that the scheme satisfies (non-adaptive) (s, c)-zero knowledge if the following holds:
(s, ∈)-(Non-Adaptive) Zero Knowledge: There exists a PPT simulator Sim such that for all sufficiently large λ, all iteration bounds T≤2^{λ}, all polynomials t=t(λ), n=n(λ), m=m(λ), all polynomial-sized circuits C: {0, 1}ⁿ×{0, 1}^{m}→{0, 1}ⁿ, all inputs x₁, xₜ∈{0, 1}ⁿ, all witnesses w=(w₁, . . . , wₜ) where w is a valid witness for (C, x₁, xₜ, t)∈ [symbol] _{IVC}, and all s=s(λ)-sized adversaries [symbol] ,

$$\vert Pr [ 𝒜 ( crs , {π}_{t} ) = 1 : \begin{matrix}crs ← IVC . Gen ( {1}^{λ} , T , {1}^{n} , {1}^{m} , C ) \\ ∀ i ∈ [ t ] , {x}_{i} = C ( {x}_{i - 1} , {w}_{i} ) , \\ ∀ i ∈ [ t ] , {π}_{i} \to IVC . 𝒫 ( crs , ( {x}_{0} , {x}_{i - 1} , i - 1 ) , {π}_{i - 1} , {w}_{i} )\end{matrix} ] - Pr [ 𝒜 ( crs , {π}_{t} ) = 1 : ( crs , {π}_{t} ) ← Sim ( {1}^{λ} , T , {1}^{n} , {1}^{m} , C , {x}_{0} , {x}_{t} , {1}^{t} ) ] \vert \leq ϵ ( λ )$$

Additionally, we say that the scheme satisfies (adaptive) (s, ∈)-zero knowledge if the following holds:
(s, ∈)-(Adaptive) Zero Knowledge: There exists a PPT simulator Sim=(Sim₁, Sim₂) such that for all sufficiently large λ, for all polynomial-sized circuits C: {0, 1}ⁿ×{0, 1}^{m}→{0, 1}ⁿ, all s=s(λ)-sized adversaries [symbol] =( [symbol] ₁, [symbol] ₂), and all iteration bounds T≤2^{λ},

$$\vert Pr [ \begin{matrix}{𝒜}_{2} ( c r s , {π}_{t} , s {t}_{2} ) = 1 : & \begin{matrix}crs ← IVC . Gen ( {1}^{λ} , T , {1}^{n} , {1}^{m} , 𝒞 ) \\ ( {x}_{0} , {w}_{1} , {w}_{2} , … , {w}_{t} , s {t}_{2} ) ← {𝒜}_{1} ( c r s , s {t}_{1} ) \\ ∀ i ∈ [ t ] , {x}_{i} = 𝒞 ( {x}_{i - 1} , {w}_{i} ) , \\ ∀ i ∈ [ t ] , {π}_{i} ← IVC . 𝒫 ( crs , ( {x}_{0} , {x}_{i - 1} , i - 1 ) , {π}_{i - 1} , {w}_{i} )\end{matrix}\end{matrix} ] - Pr [ \begin{matrix}{𝒜}_{2} ( c r s , {π}_{t} , s {t}_{2} ) = 1 : & \begin{matrix}( crs , {st}_{sim} ) ← {Sim}_{1} ( {1}^{λ} , T , {1}^{n} , {1}^{m} , 𝒞 ) \\ ( {x}_{0} , {w}_{1} , {w}_{2} , … , {w}_{t} , s {t}_{2} ) ← {𝒜}_{1} ( c r s , s {t}_{1} ) \\ ∀ i ∈ [ t ] , {x}_{i} = 𝒞 ( {x}_{i - 1} , {w}_{i} ) , \\ {π}_{t} ← {Sim}_{2} ( {x}_{0} , {x}_{t} , t , {st}_{Sim} )\end{matrix}\end{matrix} ] \vert \leq ϵ ( λ )$$

Definition 3.3 (IVC for NP with Witness-Independent Efficiency:). We say that an IVC for NP has witness-independent efficiency if on setup parameters (1^{λ}, T, 1ⁿ, 1^{m}, C), the proofs are of size |πᵢ=poly(λ, n, log T, log |C|).

### 3.2 Succinct Non-Interactive Arguments (SNARGs) and Batch Arguments (BARGs)

Definition 3.4 (Boolean Circuit Satisfiability). We define the Boolean circuit satisfiability language [symbol] _{SAT} as

$${ℒ}_{SAT} = \{ \begin{matrix}( 𝒞 , x ) : & \begin{matrix}𝒞 : {\{ 0 , 1 \}}^{n} \times {\{ 0 , 1 \}}^{m} \to \{ 0 , 1 \} , x ∈ {\{ 0 , 1 \}}^{n} , \\ ∃ w ∈ {\{ 0 , 1 \}}^{m} , 𝒞 ( x , w ) = 1\end{matrix}\end{matrix} \}$$

Definition 3.5 (SNARG for [symbol] _{SAT}). A succinct non-interactive argument (SNARG) for [symbol] _{SAT} is a tuple of PPT algorithms SNARG=(SNARG.Gen, SNARG. [symbol] , SNARG. [symbol] ) where
SNARG.Gen(1^{λ}, 1ⁿ, 1^{m}, [symbol] ): takes as input the security parameter λ, an input length n, a witness length m, and a circuit [symbol] : {0, 1}ⁿ×{0, 1}^{m}→{0, 1}, and outputs a pair of common reference strings crs=(crs [symbol] , crs [symbol] ).
SNARG. [symbol] (crs [symbol] , x, w): takes as input the prover common reference string crs, an input x∈{0, 1}ⁿ, and a witness w∈{0, 1}^{m}, and outputs a proof T.
SNARG. [symbol] (crs [symbol] , x, π): takes as input the verifier common reference string crs [symbol] , an input x∈{0, 1}ⁿ, and a proof π, and outputs a value in {0, 1}.

The scheme is additionally required to satisfy completeness and efficiency as defined below.
Completeness: For all λ∈ [symbol] , all polynomials n=n(λ), m=m(λ), all polynomial-sized circuits [symbol] : {0, 1}ⁿ×{0, 1}^{m}∈{0, 1}, all x∈={0, 1}ⁿ, and all w∈={0, 1}^{m} such that [symbol] (x, w)=1,

$$Pr [ \begin{matrix}SNARG . 𝒱 ( {crs}_{𝒱} , x , π ) = 1 : & \begin{matrix}( {crs}_{𝒫} , {crs}_{𝒱} ) ← SNARG . Gen ( {1}^{λ} , {1}^{n} , {1}^{m} , ℛ ) , \\ π ← 𝒫 ( {crs}_{𝒫} , x , w )\end{matrix}\end{matrix} ] = 1 .$$

Efficiency: There exists a polynomial p such that on setup parameters (1^{λ}, 1ⁿ, 1^{m}, [symbol] ) where [symbol] is a polynomial-sized Boolean circuit [symbol] : {0, 1}ⁿ×{0, 1}^{m}→{0, 1}, the proof has size |π|=p(λ, log |R|). Moreover, the verifier runtime is poly(λ, n, log |R|). (Note that this verifier efficiency can be generically obtained via RAM delegation techniques.)

A SNARG may satisfy either adaptive or non-adaptive soundness. We define both below:
(s, ∈)-Non-Adaptive Soundness: For all sufficiently large λ and all s=s(λ)-sized adversaries [symbol] =( [symbol] ₁, [symbol] ₂),

$$Pr [ \begin{matrix} & ( {1}^{n} , {1}^{m} , ℛ , {x}^{*} , st ) ← {𝒜}_{1} ( {1}^{λ} ) , \\ \begin{matrix}( R , {x}^{*} ) ∉ {ℒ}_{SAT} \\ ∧ 𝒱 ( {crs}_{𝒱} , {x}^{*} , {π}^{*} ) = 1\end{matrix} : & crs ← SNARG . Gen ( {1}^{λ} , {1}^{n} , {1}^{m} , ℛ ) , \\ & {π}^{*} ← {𝒜}_{2} ( crs , {x}^{*} , st )\end{matrix} ] \leq ϵ ( λ ) .$$

(s, ∈)-Adaptive Soundness: For all sufficiently large λ and all s=s(λ)-sized adversaries [symbol] =( [symbol] ₁, [symbol] ₂),

$$Pr [ \begin{matrix} & ( {1}^{n} , {1}^{m} , ℛ , st ) ← {𝒜}_{1} ( {1}^{λ} ) \\ \begin{matrix}( R , x ) ∉ {ℒ}_{SAT} \\ ∧ 𝒱 ( {crs}_{𝒱} , {x}^{*} , {π}^{*} ) = 1\end{matrix} : & crs ← SNARG . Gen ( {1}^{λ} , {1}^{n} , {1}^{m} , ℛ ) , \\ & ( {x}^{*} , {π}^{*} ) ← {𝒜}_{2} ( crs , st )\end{matrix} ] \leq ϵ ( λ ) .$$

Theorem 3.6 (Prior work). Assuming the subexponential i [symbol] and one-way functions, there exist adaptively sound SNARGs with crs size poly(λ, |R|) and proof size poly(λ).

Definition 3.7 (seBARG for [symbol] _{SAT}). A (publicly verifiable and non-interactive) somewhere extractable batch argument (seBARG) for [symbol] _{SAT} is a tuple of PPT algorithms

$$seBARG = ( seBARG . Gen , seBARG . 𝒫 , seBARG . 𝒱 , seBARG . TDGen , seBARG . Ext )$$

where
seBARG.Gen(1^{λ}, k, 1ⁿ, 1^{m}, R): takes as input the security parameter λ, a number of instances k in binary, an input length n, a witness length m, and a circuit R: {0, 1}ⁿ×{0, 1}^{m}→{0, 1}, and outputs a common reference strings crs.
seBARG. [symbol] (crs, {xᵢ}_{i∈|k|}, {wᵢ}_{i∈|k|}): takes as input a common reference string crs, statements {xᵢ}_{i∈|k|} where each xᵢ∈{0, 1}ⁿ, and witnesses {wᵢ}_{i∈|k|} where each wᵢ∈{0, 1}^{m}, and outputs a proof π.
seBARG. [symbol] (crs, {xᵢ}_{i∈|k|}, π): takes as input a common reference string crs, statements {xᵢ}_{i∈|k|} where each xᵢ∈{0, 1}ⁿ, and a proof π, and outputs a value in {0, 1}.
seBARG.TDGen(1^{λ}, k, 1ⁿ, 1^{m}, [symbol] , i*): takes as input the security parameter λ, a number of instances k in binary, an input length n, a witness length m, an NP-relation circuit [symbol] : {0, 1}ⁿ×{0, 1}^{m}→{0, 1}ⁿ, and an index i*∈[k], and outputs a common reference strings crs and a trapdoor td.
seBARG.Ext(td, {xᵢ}_{i∈|k|}, π): takes as input a trapdoor td, statements {xᵢ}_{i∈|k|} where each xᵢ∈{0, 1}ⁿ, and a proof T, and outputs a witness w∈{0, 1}^{m}.

The scheme is additionally required to satisfy completeness and efficiency as defined below.
Completeness: For all λ∈ [symbol] , all k≤2^{λ}, all polynomials n=n(λ), m=m(λ), all polynomial-sized Boolean circuits [symbol] : {0, 1}ⁿ×{0, 1}^{m}→{0, 1}, all x₁, . . . , xₖ∈{0, 1}ⁿ, all w₁, . . . , wₖ∈{0, 1}^{m} where for each i∈[k], C(xᵢ, wᵢ)=1,

$$Pr [ \begin{matrix}seBARG . 𝒱 ( crs , {\{ {x}_{i} \}}_{i ∈ [ k ]} , π ) = 1 : & \begin{matrix}crs ← seBARG . Gen ( {1}^{λ} , k , {1}^{n} , {1}^{m} , ℛ ) , \\ π ← 𝒫 ( c r s , {\{ {x}_{i} \}}_{i ∈ [ k ]} , {\{ {w}_{i} \}}_{i ∈ [ k ]} )\end{matrix}\end{matrix} ] = 1 .$$

Efficiency: There exists a polynomial p such that on setup parameters (1^{λ}, k, 1ⁿ, 1^{m}, [symbol] ) where
[symbol] is a polynomial-sized Boolean circuit [symbol] : {0, 1}ⁿ×{0, 1}^{m}→{0, 1}ⁿ, the proof has size |π|=m·p(>, log k, log | R|).

We say that an seBARG is (s, ∈)-secure if it satisfies (s, ∈)-trapdoor indistinguishability and (s, ∈)-somewhere argument of knowledge as defined below:
(s, ∈)-Index hiding For all sufficiently large λ, for all s=s(λ)-sized adversaries [symbol] , for all k≤2^{λ}, and for all i₀, i₁∈[k],

$$Pr [ \begin{matrix}𝒜 ( crs , st ) = b : & \begin{matrix}b ← \{ 0 , 1 \} \\ ( crs , td ) ← seBARG . TDGen ( {1}^{λ} , k , {1}^{n} , {1}^{m} , 𝒞 , {i}_{b} )\end{matrix}\end{matrix} ] \leq \frac{1}{2} + ϵ ( λ )$$

(s, ∈)-Somewhere Argument of Knowledge. For all sufficiently large λ, all s=s(λ)-sized adversaries [symbol] , all k≤2, and all i*∈ [symbol] ,

$$Pr [ \begin{matrix} & ( crs , td ) ← Setup ( λ , k , {1}^{n} , {1}^{m} , 𝒞 , {i}^{*} ) \\ \begin{matrix}seBARG . 𝒱 ( c r s , {\{ {x}_{i} \}}_{i ∈ [ k ]} , π ) = 1 \\ ℛ ( {x}_{{i}^{*}} , {w}_{{i}^{*}} ) = 0\end{matrix} : & ( {\{ {x}_{i} \}}_{i ∈ [ k ]} , π ) ← 𝒜 ( crs , st ) \\ & {w}_{{i}^{*}} ← seBARG . Ext ( td , {\{ {x}_{i} \}}_{i ∈ [ k ]} , π )\end{matrix} ] \leq ϵ ( λ )$$

Theorem 3.8. Constructions of seBARGs for [symbol] _{SAT} can be constructed from:
LWE.
Bilinear maps.
sub-exponential DDH.
sub-exponential DDH and quadratic residuosity.

Definition 3.9 (Rate-1 seBARG for [symbol] _{SAT}). We say that an seBARG for NP is rate-1 if there exists a polynomial p such that on setup parameters (1^{λ}, k, 1ⁿ, 1^{m}, [symbol] ) where [symbol] is a polynomial-sized Boolean circuit [symbol] : {0, 1}ⁿ×{0, 1}^{m}→{0, 1}ⁿ, the proof has size |π|=m+p(λ, log k, log |R|).

Theorem 3.10. Rate-1 seBARGs for [symbol] _{SAT} can be constructed from
polynomial LWE

polynomial DDH and any seBARG. Combined with Theorem 3.8, this can therefore be instantiated from either bilinear maps, or subexponential DDH.

Remark 3.11. Since we need subexponentially secure seBARGs, we need to subexponential underlying assumptions.

### 3.3 Non-Interactive Zero-Knowledge (NIZK)

Definition 3.12 (NIZK Proof of Knowledge for NP). A non-interactive zero-knowledge argument system (NIZK) proof of knowledge for NP is a tuple of PPT algrithms NIZK=(NIZK.Gen, NIZK. [symbol] , NIZK. [symbol] )
NIZK.Gen (1^{λ}, 1ⁿ, 1^{m}, [symbol] ): takes as input the security parameter λ, an input length n, a witness length m, and an NP-relation circuit [symbol] : {0, 1}ⁿ×{0, 1}^{m}→{0, 1}ⁿ, and outputs a common reference string crs.
NIZK. [symbol] (crs, x, w): takes as input the common reference string crs, an input x∈{0, 1}ⁿ, and a witness w∈{0, 1}^{m}, and outputs a proof T.
NIZK. [symbol] (crs, x, π): takes as input the common reference string crs, an input x∈{0, 1}ⁿ, and a proof π, and outputs a value in {0, 1}.

We additionally require the following properties.
(Perfect) Completeness: For all λ∈ [symbol] , all polynomials n=n (λ), m=m (λ), all polynomial-sized circuits [symbol] : {0, 1}ⁿ×{0, 1}^{m}→{0, 1}, all x∈={0, 1}ⁿ and w∈{0, 1}^{m} such that [symbol] (x, w)=1,

$$Pr [ \begin{matrix}NIZK . 𝒱 ( crs , x , π ) = 1 : & \begin{matrix}crs ← NIZK . Gen ( {1}^{λ} , {1}^{n} , {1}^{m} , ℛ ) , \\ π ← NIZK . 𝒫 ( crs , x , w )\end{matrix}\end{matrix} ] = 1$$

(s, ∈)-Knowledge Extraction: There exists a PPT extractor Ext such that for all sufficiently large λ, all s=s(λ)-sized adversaries [symbol] =( [symbol] ₁, [symbol] ₂),

$$Pr [ \begin{matrix}\begin{matrix} \\ \begin{matrix}NIZK . 𝒱 ( crs , x , π ) = 1 \\ ∧ ℛ ( x , {w}^{*} ) = 0\end{matrix} : \\ \end{matrix} & \begin{matrix}( {1}^{n} , {1}^{m} , ℛ , st ) ← {𝒜}_{1} ( {1}^{λ} ) \\ ( crs , td ) ← NIZK . TDGen ( {1}^{λ} , {1}^{n} , {1}^{m} , ℛ ) \\ ( x , π ) ← {𝒜}_{2} ( crs , st ) \\ {w}^{*} ← NIZK . Ext ( td , x , π )\end{matrix}\end{matrix} ] \leq μ ( λ )$$

(s, ∈)-(Non-Adaptive) Zero-knowledge: There exists a PPT simulator Sim such that for all sufficiently large A, all polynomials n=n(λ), m=m(λ), all x∈{0, 1}ⁿ and w∈{0, 1}^{m} such that [symbol] (x, w)=1, all s=s(λ)-sized adversaries [symbol] ,

$$\vert Pr [ \begin{matrix}𝒜 ( crs , x , π ) = 1 : & \begin{matrix}crs ← NIZK . Gen ( {1}^{λ} , {1}^{n} , {1}^{m} , ℛ ) , \\ π ← NIZK . 𝒫 ( c r s , x , w ) = 1\end{matrix}\end{matrix} ] - Pr [ \begin{matrix}𝒜 ( crs , x , π ) : & ( crs , π ) ← Sim ( {1}^{λ} , {1}^{n} , {1}^{m} , R , x ) ] \vert \leq ϵ ( λ )\end{matrix}$$

(s, ∈)-(Adaptive) Zero-Knowledge: There exists a PPT simulator Sim=(Sim₁, Sim₂, Sim₃) such that for all sufficiently large λ, all polynomials n=n(λ), m=m(λ), all x∈{0, 1}ⁿ and w∈{0, 1}^{m} such that [symbol] (x, w)=1, all s=s(λ)-sized adversaries [symbol] ,

$$\vert Pr [ \begin{matrix}{𝒜}^{𝒫 ( crs , \cdot , \cdot )} ( crs ) : & crs ← NIZK . Gen ( {1}^{λ} , {1}^{n} , {1}^{m} , ℛ ) ,\end{matrix} ] - Pr [ {𝒜}^{{Sim}_{2} ( st , \cdot , \cdot )} : ( crs , st ) ← Sim ( {1}^{λ} , {1}^{n} , {1}^{m} , R ) ] \vert \leq ϵ ( λ )$$

where
[symbol] (crs, x, w): If R(x, w)=0, output ⊥. Else, output π←NIZK. [symbol] (crs, x, w).
Sim₂(st, x, w): If R(x, w)=0, output ⊥. Else, output π←Sim₃(st, x).

Theorem 3.13. There exists statistical sound NIZK proof of knowledge for NP with adaptive zero-knowledge assuming either
bilinear maps.
LWE.

### 3.4 Public-Key Encryption (PKE)

Definition 3.14 (Public-Key Encryption (PKE)). A public-key encryption scheme with ciphertext size m(·) is a tuple of PPT algorithms PKE=(PKE.Gen, PKE.Enc, PKE.Dec) where
PKE.Setup(1^{λ}, 1ⁿ) is a randomized algorithm that takes as input the security parameter λ and an input length n and outputs a public key pk and a secret key sk.
PKE.Enc (pk, x) is a randomized algorithm that takes as input a public key pk and a message x∈{0, 1}ⁿ and outputs an encryption ct∈{0, 1}^{m(λ,n)} of x.
SKE.Dec(sk, ct) is a deterministic algorithm that takes as input a secret key sk and a ciphertext ct∈{0, 1}^{m(λ,n)} and outputs a value [symbol] ∈{0, 1}ⁿ.

(Perfect) Correctness: For all λ, n∈ [symbol] and every x∈{0, 1}ⁿ,

$$Pr [ PKE . Dec ( sk , PKE . Enc ( p k , x ) ) = x : ( p k , sk ) ← PKE . Setu p ( {1}^{λ} , {1}^{n} ) ] = 1$$

(s, ∈)-Security: For all sufficiently large λ∈ [symbol] and all s=s(λ)-sized adversaries [symbol] ,

$$\vert Pr [ E x p {t}_{𝒜}^{P K E} ( {1}^{λ} , 0 ) = 1 ] - P r [ E x p {t}_{𝒜}^{P K E} ( {1}^{λ} , 1 ) = 1 ] \vert \leq μ ( λ )$$

where for each b∈{0, 1} and λ∈ [symbol] , we define

$$E x p {t}_{𝒜}^{P K E} ( {1}^{λ} , b )$$

1. Parameters: [symbol] takes as input 1^{λ} and outputs an input size 1ⁿ.
2. Setup: (pk, sk)←PKE.Setup(1^{λ}, 1ⁿ)
3. Challenge Message Query:
   (a) A outputs a challenge message pair (x₀, x₁) where x₀, x₁∈{0, 1}ⁿ.
   (b) ct_{b}←PKE.Enc(pk, x_{b})
   (c) Sent ct_{b} to [symbol] .
4. Experiment Outcome: A outputs a bit b′ which is the output of the experiment.

### 4 IVC for NP

In this section, we present our main construction, assuming the following four ingredients:
A public key encryption scheme PKE=(PKE.Gen, PKE.Enc, PKE.Dec) (Theorem 3.14) scheme with
   perfect correctness.
   (poly(λ_{PKE}), 2^{λ}^{_{PKE}}^{δ}^{_{PKE}}) security, where 0<δ_{PKE}<1 is a constant.
A subexponentially sound NIZK=(NIZK.Gen, NIZK. [symbol] , NIZK. [symbol] ) proof of Knowledge for NP (Theorem 3.12) with
   perfect completeness
   2^{λ}^{_{NIZK}}^{δ}^{_{NIZK}}-knowledge extraction
   (poly(λ_{NIZK}), 2^{λ}^{_{NIZK}}^{δ}^{_{NIZK}})-computational zero knowledge, where 0<δ_{NIZK}<1 is a constant.
A subexponentially sound SNARG=(SNARG.Gen, SNARG. [symbol] , SNARG. [symbol] ) for NP with
   (poly(λ_{SNARG}), 2^{λ}^{_{SNARG}}^{δ}^{_{SNARG}})-adaptive soundness (Looking forward, since we will set the security parameter λ_{SNARG}>|x| where |x| is the instance length, we can achieve such a SNARG by simply complexity leveraging a non-adaptive SNARG.), where 0<δ_{SNARG}<1 is a constant. This is sufficient for us since we are allowing the proof size to grow polynomially with |x|.
A rate-1 seBARG=(SNARG.Gen, SNARG. [symbol] , SNARG. [symbol] ) for NP with
   (poly(λ_{seBARG}), 2^{λ}^{_{seBARG}}^{δ}^{_{seBARG}})-trapdoor indistinguishability
   (poly(λ_{seBARG}), 2^{λ}^{_{seBARG}}^{δ}^{_{seBARG}})-somewhere argument of knowledge, where 0<δ_{seBARG}<1 is a constant.

### 4.1 Parameters

On security parameter λ, iteration bound T, input size n, witness size m, and circuit C, we will instantiate our primitives with the following parameters:

| | Security | Number of | Input size | | |
|---|---|---|---|---|---|
| | Parameter | Instances | per instance | Witness Size | Circuit |
| PKE | λ_{PKE} | | n | | |
| SNARG | λ_{SNARG} | | 2n | m | [symbol] _{C, 1} |
| NIZK (level 0) | λ_{NIZK} | | n₀ = 2\|ct\| | m₀ = 2n + 2λ_{PKE} + \|π_{SNARG}\| | [symbol] _{0, pk, crs}_{_{SNARG, ν}} |
| seBARG at level 1 | λ_{seBARG} | k₁ = 2 | n₁ = 2\|ct\| | m₁ = \|π⁽⁰⁾\| | [symbol] _{1, crs}_{_{NIZK}} |
| seBARG at level [symbol] | λ_{seBARG} | [symbol] = 2 | [symbol] = 2\|ct\| | [symbol] = \| [symbol] \| + \|ct\| | [symbol] |
| for 2 ≤ [symbol] ≤ ┌log T┐ | | | | | |

where
λ_{PKE}=λ_{SNARG}=λ_{NIZK}=λ_{seBARG}=(3n+2λ)^{1/δ′} for some constant 0<δ′<min (δ_{PKE}, δ_{SNARG}, δ_{NIZK}, δ_{seBARG}).
   |ct| is the size of PKE ciphertexts under the above parameters. We can compute this to be

$$\vert ct \vert = poly ( {λ}_{P K E} , n ) = p o l y ( λ , n )$$

[symbol] _{C,1} is the NP-relation circuit for the language [symbol] _{C,1} defined in Theorem 3.1. We can compute the size of this circuit to be

$$\vert {ℛ}_{C , 1} \vert = poly ( \vert C \vert )$$

   |π_{SNARG}| is the size of SNARG proofs under the above parameters. Since the SNARG is fully succinct, we can compute this to be

$$\vert {π}_{S N A R G} \vert = poly ( {λ}_{S N A R G} , log \vert {ℛ}_{C , 1} \vert ) = poly ( λ , log \vert C \vert )$$

[symbol] _{0,pk,crs}_{_{SNARG,ν}} is the NP-relation circuit for the language [symbol] _{0,pk,crs}_{_{SNARG,ν}} defined in Equation (1) in the construction below where
   pk is a public key of the PKE scheme
   crs_{SNARG,} [symbol] is the verifier's common reference string crs [symbol] for the SNARG scheme.

Since the SNARG has succinct verification, we can compute the size of this circuit to be

$$\begin{matrix}\vert {ℛ}_{0 , p k , {crs}_{SNARG , 𝒱}} \vert = poly ( {n}_{0} , {m}_{0} , \vert PKE . Enc ( p k , \cdot ) \vert , \\ \vert SNARG . 𝒱 ( {crs}_{SNARG , 𝒱} , \cdot , \cdot ) \vert ) \\ = poly ( {λ}_{P K E} , {λ}_{S N A R G} , n , log \vert C \vert ) \\ = poly ( λ , n , log \vert C \vert )\end{matrix}$$

   |π⁽⁰⁾| is the size of NIZK proofs under the above parameters.

We can compute this to be

$$\begin{matrix}\vert {π}^{( 0 )} \vert = poly ( {λ}_{NIZK} , \vert {ℛ}_{0 , p k , {crs}_{SNARG , 𝒱}} \vert ) \\ = poly ( λ , n , log \vert C \vert )\end{matrix}$$

[symbol] _{1,crs}_{_{NIZK}} is the NP-relation circuit for the language [symbol] _{1,crs}_{_{NIZK}} defined in Equation (2) in the construction below where crs_{NIZK} is common reference string of the NIZK scheme. We can compute the size of this circuit to be

$$\begin{matrix}\vert {ℛ}_{1 , cr {s}_{NIZK}} \vert = poly ( {n}_{1} , {m}_{1} , \vert NIZK . 𝒱 ( {crs}_{NIZK} , \cdot , \cdot ) \vert ) \\ = poly ( \vert ct \vert , \vert {π}^{( 0 )} \vert , {λ}_{NIZK} , \vert {ℛ}_{0 , p k , {crs}_{SNARG , 𝒱}} \vert ) \\ = poly ( λ , n , log \vert C \vert )\end{matrix}$$

   |π⁽¹⁾| is the size of seBARG proofs at level 1 under the above parameters. Since the seBARG is rate-1, we can compute this to be

$$\begin{matrix}\vert {π}^{( 1 )} \vert = {m}_{1} + p o l y ( {λ}_{s e BARG} , log {k}_{1} , log \vert {ℛ}_{1 , cr {s}_{N I Z K}} \vert ) \\ = \vert {π}^{( 0 )} \vert + poly ( λ , log \vert {ℛ}_{1 , cr {s}_{NIZK}} \vert ) \\ = poly ( λ , n , log \vert C \vert )\end{matrix}$$

For 2≤ [symbol] ≤┐log T┌, [symbol] is the NP-relation circuit for the language [symbol] defined in Equation (3) in the construction below where crs [symbol] ₋₁ is a common reference string of the level [symbol] −1 seBARG scheme. We can compute the size of this circuit to be

$$\begin{matrix}\vert {ℛ}_{ℓ , {crs}_{ℓ - 1}} \vert = poly ( {n}_{ℓ} , {m}_{ℓ} , \vert seBARG . 𝒱 ( {crs}_{ℓ - 1} , \{ \cdot , \cdot \} , \cdot ) \vert ) \\ = poly ( \vert ct \vert , \vert {π}^{( ℓ - 1 )} \vert , {λ}_{s e B A R G} , {k}_{ℓ - 1} , \vert {ℛ}_{ℓ - 1 , {crs}_{ℓ - 1}} \vert ) \\ = poly ( λ , n , \vert {π}^{( ℓ - 1 )} \vert , \vert {ℛ}_{ℓ - 1 , {crs}_{ℓ - 1}} \vert )\end{matrix}$$

For 2≤ [symbol] ≤┐log┌, | [symbol] | is the size of seBARG proofs at level [symbol] under the above parameters.

Since the seBARG is rate-1, we can compute this to be

$$\begin{matrix}\vert {π}^{( ℓ )} \vert = {m}_{ℓ} + p o l y ( {λ}_{s e B A R G} , log {k}_{ℓ} , log \vert {ℛ}_{ℓ - 1 , {crs}_{ℓ - 1}} \vert ) \\ = \vert {π}^{( ℓ - 1 )} \vert + \vert ct \vert + poly ( λ , log \vert {R}_{l - 1 c r s l - 1} \vert ) \\ = \vert {π}^{( 1 )} \vert + ( ℓ - 1 ) \cdot \vert ct \vert + {\sum }_{ℓ = 2}^{ℓ - 1} p o l y ( {λ}_{s e B A R G} , log \vert {ℛ}_{ℓ - 1 , {crs}_{ℓ - 1}} \vert ) \\ = poly ( λ , n , ℓ , log \vert C \vert )\end{matrix}$$

We additionally assume that on security parameter λ_{PKE}, the PKE scheme encryption algorithm uses randomness of length λ_{PKE}.

Remark 4.1. If we replace our SNARG with the “trivial” proof system which consists of simply sending the witness w, then our proof sizes will additionally depend on the witness size m.

### 4.2 Construction

We now construct our IVC for NP using the parameters defined in the previous section.
IVC.Gen( [symbol] , T, 1ⁿ, 1^{m}, C):
   1. Define ( [symbol] ₘₐₓ=┐log T┌.
   2. Setup SNARG to verify one hop:
      (a) Let [symbol] _{C,1} be the NP-relation circuit for the language [symbol] _{C,1} defined in Theorem 3.1.
      (b) (crs_{SNARG,⊐}, crs_{SNARG,} [symbol] )←SNARG.Gen(1^{λ}^{_{SNARG}}, 1²ⁿ, 1^{m}, [symbol] _{C,1}).
   3. Setup NIZK for level 0 proofs to prove knowledge of a SNARG for one hop:
      (a) (pk, sk)←PKE.Gen( [symbol] , 1ⁿ).
      (b) Define

$${ℒ}_{0 , p k , {crs}_{SNARG , 𝒱}} = \{ ( {ct}_{init} , {ct}_{fin} ) : \begin{matrix}\begin{matrix}\begin{matrix}∃ ( {x}_{init} , {x}_{fin} , {r}_{init} , {r}_{fin} , {π}_{SNARH} ) such that \\ SNARG . 𝒱 ( {crs}_{SNARG , 𝒱} , ( {x}_{init} , {x}_{fin} ) , {π}_{SNARG} ) = 1\end{matrix} \\ ⋀ {ct}_{init} = PKE . Enc ( p k , {x}_{init} ; {r}_{init} )\end{matrix} \\ ⋀ {ct}_{fin} = PKE . Enc ( p k , {x}_{fin} ; {r}_{fin} )\end{matrix} \} \qquad ( 1 )$$

Let [symbol] _{0,pk,crs}_{_{SNARG,ν}} be the NP-relation circuit for the language [symbol] _{0,crs}_{_{SNARG,ν}}.
(c) (crs_{NIZK}, td_{NIZK})←NIZK.Gen( [symbol] , 1ⁿ^{₀}, 1^{m}^{₀}, [symbol] _{0,pk,crs}_{_{SNARG}})
4. Setup seBARG at level 1 to verify a batch of two NIZK proofs:
   (a) Define

$${ℒ}_{1 , {crs}_{NIZK}} = \{ ( {ct}_{init} , {ct}_{fin} ) : \begin{matrix}∃ {π}^{( 0 )} such that \\ NIZK . 𝒱 ( {crs}_{NIZK} , ( {ct}_{init} , {ct}_{fin} ) , {π}^{( 0 )} ) = 1\end{matrix} \} . \qquad ( 2 )$$

Let [symbol] _{1,crs}_{_{NIZK}} be the NP-relation circuit for the language L_{1,crs}_{_{NIZK}}.
(b) crs₁←seBARG.Gen( [symbol] , 2, 1ⁿ^{₁}, 1^{m}^{₁}, [symbol] _{1,crs}_{_{NIZK}}).
5. Setup seBARG at level [symbol] >1 to verify a batch of two level [symbol] −1 seBARG proofs:
For [symbol] ∈{2, . . . , [symbol] ₘₐₓ},
   (a) Define

$${ℒ}_{ℓ , {crs}_{ℓ - 1}} = \{ ( {ct}_{init} , {ct}_{fin} ) : \begin{matrix}\begin{matrix}∃ ( {ct}_{mid} , {π}^{( ℓ - 1 )} ) such that \\ seBARG . 𝒱 ( {crs}_{ℓ - 1} , \{ ( {ct}_{init} , {ct}_{mid} ) , ( {ct}_{mid} , {ct}_{fin} ) \} ,\end{matrix} \\ {π}^{( ℓ - 1 )} ) = 1\end{matrix} \} . \qquad ( 3 )$$

Let [symbol] be the NP-relation circuit for the language [symbol] .
(b) crs [symbol] ←seBARG.Gen(1^{λ}^{_{seBARG}}, 2, 1 [symbol] , 1 [symbol] , [symbol] ).
6. Output crs:=( [symbol] ₘₐₓ, C, pk, crs_{SNARG}, crs_{NIZK}, { [symbol] ).
IVC. [symbol] (crs, (x₀, xᵢ₋₁, i−1), Πᵢ₋₁, wᵢ):
   1. Parse crs=( [symbol] ₘₐₓ, C, pk, crs_{SNARG}, crs_{NIZK}, { [symbol] ).
   2. Compute base case values: If i=1,
      (a) Sample r₀←{{0,1 [symbol] .
      (b) ct₀←PKE.Enc(pk, x₀; r₀).
      (c) For [symbol] ∈{0, . . . , [symbol] ₘₐₓ}, define [symbol] =θ.
   3. Verify proof of previous iteration: If i>1,

$$\begin{matrix}( a ) & \\ Parse {Π}_{i - 1} = ( c {t}_{0} , {ct}_{i - 1} , {r}_{0} , {r}_{i - 1} , {\{ {S}^{( ℓ )} \}}_{ℓ ∈ \{ 0 , … , {ℓ}_{max} \}} ) . & \end{matrix}$$

$$\begin{matrix}( b ) & \\ If IVC . 𝒱 ( crs , ( {x}_{0} , {x}_{i - 1} , i - 1 ) , {Π}_{i - 1} ) = 0 , output ⊥ . & \end{matrix}$$

4. Compute NIZK proof πᵢ⁽⁰⁾ for iteration i:

$${x}_{i} = C ( {x}_{i - 1} , {w}_{i} ) . \qquad ( a )$$

(b) π_{SNARG}←SNARG. [symbol] (crs_{SNARG,} [symbol] , (xᵢ₋₁, xᵢ), wᵢ).
(c) rᵢ←{0, 1 [symbol] .
(d) ctᵢ←PKE.Enc(pk, xᵢ; rᵢ).
(e) πᵢ⁽⁰⁾←NIZK. [symbol] (crs_{NIZK}, (ctᵢ₋₁, ctᵢ), (xᵢ₋₁, xᵢ, rᵢ₋₁, rᵢ, π_{SNARG}).
(f) Add (i−1, ctᵢ₋₁, ⊥, ctᵢ, πᵢ⁽⁰⁾) to S⁽⁰⁾.
5. Merge proofs: For [symbol] ∈{0, . . . , [symbol] ₘₐₓ−1},
   (a) Check if there are two proofs at level l:
      i. If | [symbol] |<2, continue to the next iteration. If | [symbol] |>2, output ⊥.

$$If \vert {S}^{( ℓ )} \vert = 2 , parse {S}^{( ℓ )} = \{ ( {i}_{init} , {ct}_{init} , {ct}_{mid} , {ct}_{fin} , {π}^{( ℓ )} ) , ( , , , , {\tilde{π}}^{( ℓ )} ) \} , and set {S}^{( ℓ )} = ⊥ . \qquad ii .$$

(b) Verify adjacency of the two proofs: If ct_{fin}≠ [symbol] or iᵢₙᵢₜ+ [symbol] ≠ [symbol] , output ⊥.
(c) Create a level [symbol] +1 seBARG proof for the two level [symbol] proofs:
   i. If [symbol] =0, compute
   π⁽¹⁾←seBARG. [symbol] (crs₁, {(ctᵢₙᵢₜ,ct_{fin}), ( [symbol] , [symbol] )}, {π⁽⁰⁾, [symbol] })
   and add (iᵢₙᵢₜ, ctᵢₙᵢₜ, ct_{fin}, [symbol] , π⁽¹⁾) to S⁽¹⁾.
   ii. If [symbol] ≥1, compute [symbol]
   ←seBARG. [symbol] ( [symbol] , {(ctᵢₙᵢₜ, ct_{fin}), ( [symbol] , [symbol] )},
   {(ct_{mid}, [symbol] ), ( [symbol] , [symbol] }) and add (iᵢₙᵢₜ, ctᵢₙᵢₜ, ct_{fin}, [symbol] , [symbol] ) to [symbol] .
6. Output Πᵢ=(ct₀, ctᵢ, r₀, rᵢ, { [symbol] } [symbol] ).
IVC. [symbol] (crs, (x₀, xₜ, t), Πₜ):
   1. Parse

$$crs = ( {ℓ}_{max} , C , pk , {crs}_{SNARG} , {crs}_{NIZK} , {\{ {crs}_{ℓ} \}}_{ℓ ∈ [ {ℓ}_{max} ]} )$$

and

$${\prod }_{t} = ( {ct}_{0} , {ct}_{t} , {r}_{0} , {r}_{t} , {\{ {S}^{( ℓ )} \}}_{ℓ ∈ \{ 0 , … , {ℓ}_{max} \}} ) .$$

2. Let i_{curr}=0 and ct_{curr}=ct₀.
3. Verify proofs at each level: For [symbol] ∈{ [symbol] ₘₐₓ, [symbol] ₘₐₓ−1, . . . , 0},
   (a) Check if there is a proof at level:
      i. Let s [symbol] be the [symbol] least significant bit in the binary representation of t. That is, we define [symbol] . . . s₁s₀ to be the ( [symbol] ₘₐₓ+1)-bit binary number representing t (with leading zeros added as necessary).
      ii. If [symbol] =0, continue to the next iteration.
      iii. If [symbol] =1, parse [symbol] ={iᵢₙᵢₜ, ctᵢₙᵢₜ, ct_{mid}, ct_{fin}, [symbol] }.
      Output 0 if [symbol] is not of this form.
   (b) Verify adjacency with previous proof:
      i. If i_{curr}≠iᵢₙᵢₜ or ct_{curr}≠ctᵢₙᵢₜ, output 0.
      ii. Set i_{curr}=i_{curr}+ [symbol] and ct_{curr}=ct_{fin}.
   (c) Verify proof at level l:
      i. If [symbol] =0 and NIZK. [symbol] (crs_{NIZK}, (ctᵢₙᵢₜ, ct_{fin}), π⁽⁰⁾)=0, output 0.
      ii. [symbol] ≥1 and seBARG. [symbol] (crs [symbol] , {(ctᵢₙᵢₜ, ct_{mid}), (ct_{mid}, ct_{fin})}, [symbol] )=0, output 0.
   4. Verify the ciphertexts: If ct_{curr}≠ct [symbol] , PKE.Enc(pk, x₀; r₀)≠ct₀, or PKE.Enc(pk, xₜ; rₜ)≠ct [symbol] , output 0.
   5. Output 1.

### 4.3 Correctness and Efficiency

Correctness. The correctness of our scheme follows in a straightforward manner from the correctness of the PKE, NIZK, SNARG, and seBARG.

The proof for (x₀, xₜ, t) is Πₜ=(ct₀, ctₜ, x₀, rₜ{ [symbol] } [symbol] ). Under an honest prover, ct₀ and ctₜ will indeed be encryptions of x₀ and xₜ using randomness r₀ and rₜ. Additionally, for each [symbol] ∈ [symbol] ₘₐₓ, except with negligible probabilty, the NIZK or seBARG proof contained in [symbol] will correctly verify. This is because for each level [symbol] , an honest prover will generate a NIZK or seBARG proof of a true statement (except with some negligible probability corresponding to the probability that at some previous step, some SNARG/NIZK/seBARG proof of a true statement does not verify).

Efficiency. We now argue that our scheme is efficient. That is, on setup parameters (1^{λ}, T, 1ⁿ, 1^{m}, C) where C is a polynomial-sized circuit C: {0, 1}ⁿ×{0, 1}^{m}→{0, 1}ⁿ,
All algorithms run in time poly(λ, n, log T, |C|).
The proof size is poly(λ, n, log T, log |C|).

We begin by analyzing the proof size. For an honest prover and for t≤T, the proof for (x₀, xₜ, t) is

$${\prod }_{t} = ( {ct}_{0} , {ct}_{t} , {r}_{0} , {r}_{t} , {\{ {S}^{( ℓ )} \}}_{ℓ ∈ \{ 0 , … , {ℓ}_{max} \}} )$$

where [symbol] ₘₐₓ=┐log T┌ and each [symbol] contains at most one tuple of the form (iᵢₙᵢₜ, ctᵢₙᵢₜ, ct_{mid}, ct_{fin}, [symbol] ). Thus based on the parameters in Section 4.1,

$$\begin{matrix}\vert {\prod }_{t} \vert \leq 2 \vert ct \vert + 2 {λ}_{PKE} + {\sum }_{ℓ = 0}^{{ℓ}_{max}} ( {ℓ}_{max} + 2 \vert ct \vert + \vert {π}^{( ℓ )} \vert ) \\ \leq 2 \vert ct \vert + 2 {λ}_{PKE} + ( {ℓ}_{max} + 1 ) ( {ℓ}_{max} + 2 \vert ct \vert + poly ( λ , {ℓ}_{max} , n ) ) \\ = poly ( λ , n , {ℓ}_{max} , log \vert C \vert ) \\ = poly ( λ , n , log T , log \vert C \vert )\end{matrix}$$

It is then easy to see that our algorithms all run in time poly(λ, log T, |C|).

Remark 4.2. We remark that if we replace our SNARG with the “trivial” proof system which consists of simply sending the witness w, then our proof sizes will additionally depend on the witness size m.

### System Implementations

Incrementally verifiable computation may provide a framework for verifying distributed computations across multiple untrusted nodes while maintaining computational efficiency and cryptographic security. In some cases, a method for verifying the execution of any distributed computation C across multiple untrusted nodes starting from a configuration x₀ may enable verification where each node computes from the previous configuration xᵢ the next configuration xᵢ₊₁ dependent on C and a nondeterministic input wᵢ. The method may additionally achieve zero knowledge for the witnesses used at each step of computation, providing privacy preservation throughout the verification process.

The distributed computation verification system may operate through a sequence of state transitions where computation C transforms an initial configuration x₀ through successive intermediate configurations. In some cases, each configuration xᵢ may represent a computational state that encodes the current status of the distributed computation. The transition from configuration xᵢ to configuration xᵢ₊₁ may depend on both the computation C and a nondeterministic input wᵢ, where the nondeterministic input wᵢ may provide additional data or randomness for the computation step.

The hierarchical proof structure may enable logarithmic scaling of verification complexity rather than linear scaling with the number of computation steps. In some cases, the maximum level [symbol] ₘₐₓ of the proof hierarchy may be calculated as the base-2 logarithm of iteration bound T, expressed mathematically as [symbol] ₘₐₓ=log₂(T). This logarithmic relationship may provide computational advantages when verifying long sequences of distributed computations, as the proof size and verification time may grow logarithmically rather than linearly with the number of steps.

The cryptographic foundations of the system may rely on succinct non-interactive arguments (SNARGs) and somewhere extractable batch arguments (seBARGs). SNARGs may provide succinct proofs that demonstrate the correctness of individual computation steps without revealing the underlying witnesses. In some cases, a SNARG may prove that a transition from configuration xᵢ to configuration xᵢ₊₁ using nondeterministic input wᵢ follows the rules of computation C. The succinctness property may ensure that the proof size remains small regardless of the complexity of the computation step being verified.

seBARGs may enable the aggregation of multiple proofs into a single batch proof, facilitating the hierarchical structure of the verification system. In some cases, seBARGs may combine multiple lower-level proofs into a higher-level proof that covers a larger segment of the computation sequence. The somewhere extractable property may provide security guarantees that enable the extraction of witnesses from valid proofs, supporting the soundness of the verification system.

The security parameter λ may determine the cryptographic strength of the verification system. In some cases, the security parameter λ may influence the size of cryptographic keys, the length of random strings, and the computational hardness assumptions underlying the proof system. The choice of security parameter λ may balance security requirements against computational efficiency, where larger values of λ may provide stronger security guarantees at the cost of increased computational overhead.

Zero knowledge properties may be achieved through cryptographic techniques that hide the nondeterministic inputs w; while still proving the correctness of the computation steps. In some cases, the zero knowledge property may ensure that a verifier can confirm the validity of the computation without learning any information about the witnesses wᵢ used in the computation. This privacy preservation may be particularly valuable in distributed computing scenarios where the nondeterministic inputs wᵢ may contain sensitive or proprietary information.

The distributed nature of the computation may involve multiple untrusted nodes that participate in the computation process without requiring trust relationships between nodes. In some cases, each node may receive a configuration xᵢ from a previous node, perform a computation step to generate configuration xᵢ₊₁, and provide cryptographic proof of the correctness of the computation. The untrusted nature of the nodes may be addressed through the cryptographic verification mechanisms that enable detection of incorrect or malicious computations.

The verification process may accommodate arbitrary distributed computations C, providing flexibility in the types of computations that can be verified. In some cases, computation C may represent complex algorithms, data processing operations, or mathematical calculations that are distributed across multiple nodes for performance or reliability reasons. The generality of the approach may enable verification of diverse computational tasks while maintaining the same underlying cryptographic framework.

Referring to FIG. 1, a base level proof structure may be implemented for incrementally verifiable computation using succinct non-interactive arguments (SNARG). The diagram illustrates how individual computation steps may be verified at level 0) of a hierarchical proof system. In some cases, the system may receive security parameters ( [symbol] , T) via an electronic interface, where λ represents a security parameter and T represents an iteration bound that defines the computational scope.

The system may calculate [symbol] ₘₐₓ as a base-2 logarithm of T rounded up to the nearest integer, providing a representation of the maximum level of the proof hierarchy. This calculation may establish the structural bounds for the hierarchical verification system and may determine how many levels of proof aggregation the system can support.

As shown in FIG. 1, the SNARG proof generation process may begin with generating a SNARG common reference string crs_{SNARG} for a language L_{SNARG}. The language L_{SNARG} may contain all tuples (x₀, x₁) such that there exists a witness w such that C(x₀, w)=x₁, where C represents a computation function that transforms an initial configuration x₀ using witness w to produce a subsequent configuration x₁. In some cases, the SNARG common reference string crs_{SNARG} may be generated using one of several cryptographic assumptions, including a learning with errors (LWE) assumption with subexponential security parameter λ, a bilinear maps assumption with subexponential security parameter λ, or an indistinguishability obfuscation assumption with subexponential security parameter).

The SNARG proof generation box depicted in FIG. 1 may receive inputs St and W, where St represents a pair of configurations and W represents a witness. The system may generate a SNARG proof π_{SNARG} at level (using crs_{SNARG} for (x₀, x₁) with witness w₀, and may output this as Π₁. In some cases, the system may generate additional SNARG proofs π_{SNARG} at level 0 using crs_{SNARG} for subsequent configuration pairs (xᵢ, xᵢ₊₁).

With continued reference to FIG. 1, the two circular nodes may contain configurations xₖ and xₖ₊₁, representing consecutive states in the computation sequence. The curved arrow labeled wₖ₊₁ may indicate a state transition from configuration xₖ to configuration xₖ₊₁ using witness wₖ₊₁. This witness may provide the nondeterministic input necessary to verify that the computation step from xₖ to xₖ₊₁ follows the defined computation function C.

The SNARG proof π_{SNARG} may establish the validity of single computation steps by demonstrating that the transition from one configuration to the next adheres to the computational rules defined by function C. In some cases, the proof may verify that given an initial configuration xₖ and witness wₖ₊₁, the computation function produces the expected subsequent configuration xₖ₊₁. The SNARG construction may provide succinctness, meaning the proof size remains small regardless of the complexity of the underlying computation being verified.

The level 0 proof structure may serve as the foundation for higher-level proof aggregation in the hierarchical system. Each SNARG proof may verify a single computational step, and these individual proofs may later be combined into batch arguments at higher levels of the hierarchy. The common reference string crs_{SNARG} may enable multiple parties to generate and verify proofs for the same language L_{SNARG} without requiring trusted interaction during the proof generation phase.

Referring to FIG. 2, the hierarchical proof structure demonstrates a first level proof merging process that combines two level 0 SNARG proofs into a unified level 1 batch argument. The diagram illustrates how individual computation steps may be aggregated to create more efficient proof representations while maintaining cryptographic security guarantees.

The level 1 proof structure shown in FIG. 2 comprises a BARG component labeled

$${π}_{( k + 2 ) / 2}^{( 1 )}$$

positioned at the top level of the hierarchy. This BARG component receives inputs St and W, where St represents pairs of configurations (xₖ, xₖ₊₁) and (xₖ₊₁, xₖ₊₂), and W represents witnesses

$${π}_{k + 1}^{( 0 )} and {π}_{k + 2}^{( 0 )}$$

from the lower level proofs. The method may generate a rate-1 somewhere extractable batch argument (seBARG) common reference string crs₁ for the language that contains all tuples (x₀, ⊥, x₁) for which there exists a SNARG proof π_{SNARG} that (x₀, x₁) is in L_{SNARG}.

As further shown in FIG. 2, two SNARG boxes are positioned below the BARG component, representing level 0 proofs in the hierarchical structure. The left SNARG box is labeled

$${π}_{k + 1}^{( 0 )}$$

and the right SNARG box is labeled

$${π}_{k + 2}^{( 0 )} .$$

These SNARG proofs establish relationships between consecutive configurations, with the left SNARG connecting configurations xₖ and xₖ₊₁, while the right SNARG connects configurations xₖ₊₁ and xₖ₊₂. The intermediate configuration xₖ₊₁ serves as a connection point between the two level 0 proofs, ensuring continuity in the computation sequence.

The batch argument merging algorithm combines the two level (SNARG proofs using the seBARG construction. For level 0) proofs, the method may compute a level 1 somewhere extractable batch argument (seBARG) proof that combines the two level 0 proofs using the seBARG merging algorithm with crs₁. The merging process receives a first proof π₁ for configurations ( [symbol] ) and a second proof π₂ for configurations ( [symbol] ), where the endpoint configuration [symbol] matches between the two proofs.

With continued reference to FIG. 2, the curved arrows labeled wₖ₊₁ and wₖ₊₂ represent witnesses or nondeterministic inputs used in the state transitions. These witnesses provide the computational evidence needed to verify the validity of each state transition. The arrow wₖ₊₁ curves from xx toward xₖ₊₁, while the arrow wₖ₊₂ curves from xₖ₊₁ toward xₖ₊₂, demonstrating the sequential nature of the computation steps.

The rate-1 somewhere extractable batch argument (seBARG) common reference strings may be generated using cryptographic assumptions that provide subexponential security. The method may utilize a learning with errors (LWE) assumption with subexponential security parameter λ, providing post-quantum security guarantees. Alternatively, the system may employ a bilinear maps assumption with subexponential security parameter λ, leveraging elliptic curve cryptography for efficient proof generation. In some cases, the method may use a discrete logarithm assumption with subexponential security parameter λ, offering computational security based on the difficulty of solving discrete logarithm problems.

The merging process at level [symbol] follows a structured approach that maintains proof integrity while achieving size efficiency. The method may verify that the endpoint configuration [symbol] matches between the two proofs, ensuring proper alignment of computation segments. The system may then compute a level [symbol] +1 somewhere extractable batch argument proof [symbol] that combines π₁ and π₂ using the seBARG merging algorithm with [symbol] . The merged proof [symbol] may be output along with configurations xᵢ, [symbol] , and [symbol] , providing a compact representation of the combined computation steps.

The hierarchical structure illustrated in FIG. 2 demonstrates how the BARG at level 1 aggregates two level 0 SNARG proofs, creating a more compact representation of the computation path. The connections between components show the flow of proof generation, with lower-level proofs serving as inputs to higher-level batch arguments. This aggregation process reduces the overall proof size while maintaining the cryptographic guarantees provided by the underlying SNARG constructions.

The somewhere extractable property of the batch argument enables efficient verification of the combined computation steps. The rate-1 property ensures that the proof size grows linearly with the number of computation steps being verified, providing scalability for large computation sequences. The common reference string crs₁ contains the cryptographic parameters needed to generate and verify the batch arguments, establishing a trusted setup for the proof system.

Referring to FIG. 3, the hierarchical proof construction demonstrates how proofs may be recursively merged across multiple levels to create a scalable verification system. The diagram illustrates a level j proof structure where two level j−1 BARG proofs are combined to form a higher-level proof that spans a broader computational range.

The system may generate a series of rate-1 somewhere extractable batch argument (seBARG) common reference strings { [symbol] where for each level [symbol] , the seBARG is for the language that contains tuples (x₀, x₁, x₂) for which there exist (x_{L}, π_{L}) and (x_{R}, π_{R}) such that π_{L} is a previous level seBARG for (x₀, x_{L}, x₁) and π_{R} is a previous level seBARG for (x₁, x_{R}, x₂). This construction enables the hierarchical merging of proofs by establishing a formal language structure that defines valid proof combinations at each level.

As shown in FIG. 3, the top-level BARG box labeled

$${π}_{1}^{( j )}$$

represents a level j proof that aggregates two subordinate proofs. The left BARG box

$${π}_{L}^{( j - 1 )}$$

and the right BARG box

$${π}_{R}^{( j - 1 )}$$

represent level j−1 proofs that serve as inputs to the higher-level proof construction. Each of these lower-level proofs may cover a specific computational segment, with the left proof spanning configurations from xᵢₙᵢₜ to x_{mid} and the right proof spanning configurations from x_{mid} to x_{fin}.

The intermediate configuration x_{mid} serves as a connection point between the two level j−1 proofs, ensuring continuity in the computational sequence. This intermediate state may be included in both subordinate proofs, creating an overlap that enables the verification of proper state transitions across the merged computational segments. The hierarchical structure allows the system to combine proofs that cover different portions of a computation while maintaining cryptographic soundness.

For proofs at level [symbol] greater than 1, the system may compute a seBARG proof at level [symbol] +1 that combines the two proofs using the seBARG merging algorithm with [symbol] , including the intermediate state. This merging process takes two proofs from level [symbol] and produces a single proof at level [symbol] +1 that covers the combined computational range of both input proofs. The merging algorithm may utilize the common reference string [symbol] to ensure that the resulting proof maintains the same security properties as the individual component proofs.

The recursive nature of this construction enables logarithmic proof size growth relative to the number of computation steps being verified. As computational sequences are merged at each level, the total number of proofs decreases exponentially while the coverage of each proof increases correspondingly. A computation with 2 steps may be represented by a single proof at level k, rather than 2 k individual step proofs, resulting in significant compression of the proof structure.

With continued reference to FIG. 3, the witness inputs W for each BARG component may include the proofs from the previous level, creating a chain of dependencies that extends down to the base level SNARG proofs. The statement inputs St for each component may specify the configuration pairs that define the computational range covered by that particular proof. This hierarchical organization allows the system to efficiently verify large computations by checking a logarithmic number of proofs rather than examining each individual computation step.

The seBARG common reference strings may be generated during the setup phase to support proof merging at each level of the hierarchy. Each level [symbol] may have a corresponding crs [symbol] that defines the cryptographic parameters for merging proofs at that level. The somewhere extractable property of these batch arguments enables the extraction of individual proof components when needed for verification or debugging purposes, while maintaining the efficiency benefits of batch processing.

### Zero-Knowledge Verification Protocol

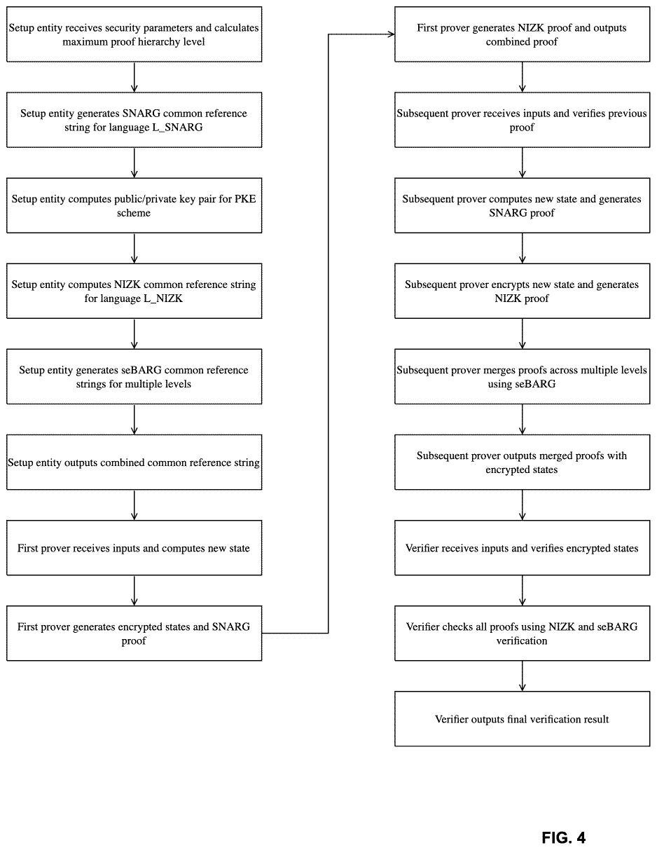

Referring to FIG. 4, the zero-knowledge distributed computation verification method may comprise a comprehensive protocol that enables secure verification of distributed computations while preserving privacy of intermediate computational states. The method may incorporate multiple cryptographic primitives including public key encryption (PKE), non-interactive zero-knowledge (NIZK) proofs, and somewhere extractable batch arguments (seBARG) to create a hierarchical verification system.

The setup phase may begin with a setup entity comprising at least one computerized processor and memory. The setup entity may compute, using the at least one processor, a public key and secret key pair (pk, sk) of a public key encryption (PKE) scheme. This key pair may serve as the foundation for encrypting computational states throughout the verification process. The setup entity may further compute, using the at least one processor, a non-interactive zero knowledge (NIZK) common reference string crs_{NIZK} for a language L_{NIZK} that contains all tuples (ct₀, ct₁) for which there exist a tuple (x₀, x₁, r₀, r₁, π) such that ct_{b}=PKE.Enc(pk, x_{b}) with randomness r, and π is a valid SNARG for (x₀, x₁).

The setup entity may generate, using the at least one processor, a rate-1 somewhere extractable batch argument (seBARG) common reference string crs₁ for the language that contains all tuples (ct₀, ⊥, ct₁) for which there exists a NIZK proof π_{NIZK} that (ct₀, ct₁) is in L_{NIZK}. The setup entity may store the generated reference strings in the memory and may output, via an electronic interface, a combined common reference string crs:=(pk, crs_{SNARG}, crs_{NIZK}, [symbol] ).

As shown in FIG. 4, the proof generation process may involve multiple prover entities that sequentially build upon previous computations while maintaining zero-knowledge properties. A first prover entity comprising at least one computerized processor and memory and in electronic communication with the setup entity may receive, via an electronic interface, the combined common reference string ers. The first prover entity may receive, via an electronic interface, inputs x₀ and a witness w₀, and may compute, using the at least one processor, a new state x₁=C(x₀, w₀).

The first prover entity may sample, using the at least one processor, randomness r₀ and r₁, and may compute, using the at least one processor, ct₀ as an encryption of x₀ under pk using randomness r₀, and may compute ct₁ as an encryption of x₁ under pk using randomness r₁. The encryption of configurations as ct₁ may enable the system to maintain privacy of intermediate computational states while allowing verification of computation correctness. The first prover entity may generate, using the at least one processor, a NIZK proof π_{NIZK} at level 0 of (ct₀, ct₁) using crs_{NIZK} and witness (x₀, x₁, r₀, r₁, π_{SNARG}). The NIZK proof π_{NIZK} may demonstrate validity of the encrypted states without revealing the actual intermediate values. The first prover entity may store the generated proofs in the memory and may output, via an electronic interface, (r₀, r₁, ct₀, ct₁, π_{NIZK}) as Π₁.

With continued reference to FIG. 4, a subsequent prover entity comprising at least one computerized processor and memory and in communication with both the setup entity and the first prover entity or a previous prover entity may extend the computation chain. The subsequent prover entity may receive, via an electronic interface, the combined common reference string crs and may receive, via an electronic interface, inputs (x₀, xᵢ, i), a proof Πᵢ, and a witness wᵢ, where Πᵢ is of the form (r₀, rᵢ, ct₀, ctᵢ, Sᵢ) where Sᵢ is a set of NIZK and seBARG proofs.

The subsequent prover entity may verify, using the at least one processor, Πᵢ is a proof for (x₀, xᵢ, i) using the same method as the verifier entity. The subsequent prover entity may compute, using the at least one processor, a new state xᵢ₊₁=C(xᵢ, wᵢ) and may sample, using the at least one processor, randomness rᵢ₊₁. The subsequent prover entity may compute, using the at least one processor, ctᵢ₊₁ as an encryption of xᵢ₊₁ under pk using randomness rᵢ₊₁.

The subsequent prover entity may generate, using the at least one processor, a NIZK proof π_{NIZK} at level 0 of (ctᵢ, ctᵢ₊₁) using crs_{NIZK} and witness (xᵢ, cᵢ₊₁, rᵢ, rᵢ, π_{SNARG}) where (ctᵢ, rᵢ) come from Πᵢ. The merging of NIZK and seBARG proofs across hierarchy levels may create a hierarchical structure that enables efficient verification of long computation sequences.

The subsequent prover entity may merge, using the at least one processor, proofs Πᵢ and π_{NIZK} to create a higher-level proof by repeating a process for all levels from 0 to [symbol] ₘₐₓ−1. The merging process may check if there are two seBARG or NIZK proofs at level [symbol] in the proof set Sᵢ of Πᵢ and if not, may continue to the next level. The process may verify the adjacency of the two proofs by comparing end states and indices.

For level 0 proofs, the subsequent prover entity may compute a level 1 somewhere extractable batch argument (seBARG) proof that combines the two level 0 proofs using the seBARG merging algorithm with crs₁. For proofs at level [symbol] greater than 1, the subsequent prover entity may compute a seBARG proof at level [symbol] +1 that combines the two proofs using the seBARG merging algorithm with crs [symbol] , including the intermediate state. The subsequent prover entity may add the newly created higher-level proof to the set of proofs at the next level.

The merging process at level (may comprise receiving a first proof π₁ for ciphertexts ( [symbol] ) and a second proof π₂ for ciphertexts ( [symbol] ). The process may verify that the intermediate ciphertext [symbol] matches between the two proofs and may compute a level [symbol] +1 somewhere extractable batch argument proof [symbol] that combines π₁ and π₂ using the seBARG merging algorithm with [symbol] . The process may output the merged proof [symbol] along with ciphertexts ctᵢ, [symbol] , and [symbol] .

The subsequent prover entity may store the merged proofs in the memory and may output, via an electronic interface, Πᵢ: =(r₀, rᵢ₊₁, ct₀, ctᵢ₊₁, Sᵢ₊₁) where Sᵢ₊₁ contains merged proofs and represents the new set of merged seBARG and NIZK proofs at each level.

As further shown in FIG. 4, the verification phase may involve a verifier entity comprising at least one computerized processor and memory and in electronic communication with the prover entity. The verifier entity may receive, via an electronic interface, the combined common reference string ers and may receive, via an electronic interface, inputs (x₀, xₜ, t) and a proof Πₜ, where Πₜ is of the form (r₀, rₜ, ct₀, ctₜ, Sₜ) where St is a set of NIZK and seBARG proofs.

The verification process may check encrypted states ct₀ and ctₜ using randomness r₀ and rₜ respectively. The verifier entity may verify, using the at least one processor, ct₀ is an encryption of x₀ under pk using r₀ and ctₜ is an encryption of xₜ under pk using rₜ. The verifier entity may verify, using the at least one processor, proofs in St at each level using the corresponding NIZK and seBARG verification algorithms. The verification of proofs in set St at each level may enable the verifier to confirm the correctness of the entire computation sequence without accessing intermediate computational states. The verifier entity may output, via an electronic interface, a verification result.

The cryptographic foundations of the protocol may utilize various computational assumptions. The succinct non-interactive argument (SNARG) common reference string crs_{SNARG} and the non-interactive zero knowledge (NIZK) common reference string crs_{NIZK} may be generated using one of: a learning with errors (LWE) assumption with subexponential security parameter λ; a bilinear maps assumption with subexponential security parameter λ; or an indistinguishability obfuscation assumption with subexponential security parameter λ.

The rate-1 somewhere extractable batch argument (seBARG) common reference strings [symbol] may be generated using one of: a learning with errors (LWE) assumption with subexponential security parameter λ; a bilinear maps assumption with subexponential security parameter λ; or a discrete logarithm assumption with subexponential security parameter λ. These cryptographic assumptions may provide the security guarantees for the zero-knowledge properties and soundness of the verification protocol.

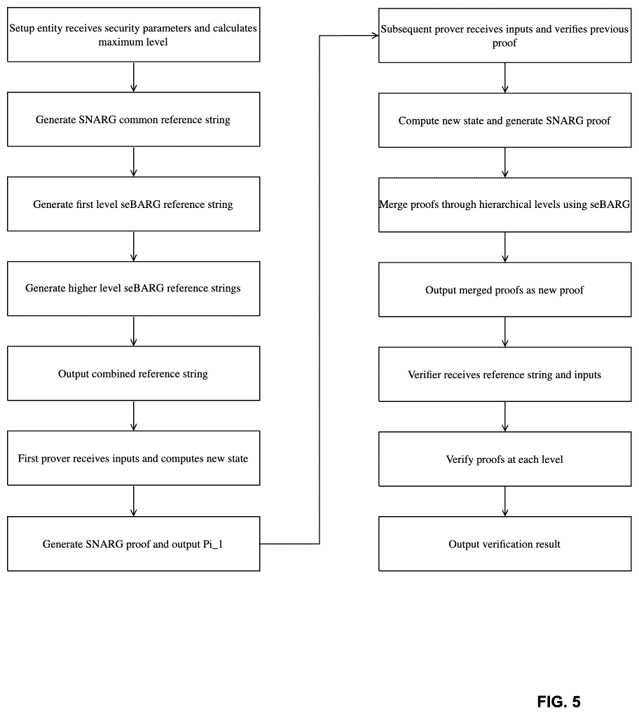

Referring to FIG. 5, a standard distributed computation verification method may be implemented through coordinated operations between multiple entities in a distributed system. The method may provide a streamlined approach to verifying computational integrity across distributed environments without the complexity of zeroknowledge encryption layers.

The setup entity may receive security parameters ( [symbol] , T) as input parameters for initializing the verification system. The setup entity may calculate a maximum proof hierarchy level [symbol] ₘₐₓ based on the received security parameters and computational requirements. The setup entity may generate a SNARG common reference string crs_{SNARG} for creating succinct non-interactive arguments. The setup entity may compute seBARG common reference strings { [symbol] for each level in the proof hierarchy, where each level corresponds to a different aggregation stage in the hierarchical proof structure. The setup entity may combine these reference strings into a unified common reference string crs:=(crs_{SNARG}, { [symbol] ). The setup entity comprising at least one computerized processor and memory may store the generated reference strings in the memory for subsequent access by other entities in the system. The setup entity may output, via an electronic interface, the combined common reference string ers to enable distributed proof generation and verification operations.

The first prover entity comprising at least one computerized processor and memory and in electronic communication with the setup entity may initiate the distributed computation verification process. The first prover entity may receive, via an electronic interface, the combined common reference string ers from the setup entity. The first prover entity may receive, via an electronic interface, inputs x₀ representing an initial state and a witness w₀ representing computational evidence or nondeterministic input. The first prover entity may compute, using the at least one processor, a new state x₁=C(x₀, w₀) by applying a computation function C to the initial state and witness. The first prover entity may generate a SNARG proof π_{SNARG} demonstrating the validity of the state transition from x₀ to x₁. The first prover entity may create a proof Π₁ containing the SNARG proof and associated state information. The first prover entity may transmit, via an electronic interface, Π₁ to a subsequent prover entity for continued computation verification.

As shown in FIG. 5, the subsequent prover entity comprising at least one computerized processor and memory and in communication with both the setup entity and the first prover entity or a previous prover entity may continue the distributed verification process. The subsequent prover entity may receive, via an electronic interface, the combined common reference string ers from the setup entity. The subsequent prover entity may receive, via an electronic interface, inputs (x₀, xᵢ, i) representing the initial state, current state, and step index, along with a proof Πᵢ from a previous prover and a witness wᵢ for the current computation step. The subsequent prover entity may verify, using the at least one processor, that Πᵢ is a valid proof for (x₀, xᵢ, i) using the same verification method employed by the verifier entity. The subsequent prover entity may compute, using the at least one processor, a new state xᵢ₊₁=C(xᵢ, wᵢ) by applying the computation function to the current state and witness.

The subsequent prover entity may generate a new SNARG proof π_{SNARG} for the state transition from xᵢ to xᵢ₊₁. The subsequent prover entity may merge, using the at least one processor, proofs Πᵢ and π_{SNARG} to create a higher-level proof through a hierarchical aggregation process. The merging process may repeat for all levels from 0 to [symbol] ₘₐₓ−1, where [symbol] ₘₐₓ represents the maximum level of the proof hierarchy. At each level [symbol] , the subsequent prover entity may check if there are two proofs available for merging, and if not, may continue to the next level without performing aggregation operations. When two proofs are available at a given level, the subsequent prover entity may verify the adjacency of the two proofs by comparing end states and indices to confirm computational continuity. The subsequent prover entity may compute a seBARG proof using a merging algorithm with the corresponding crs [symbol] ₊₁ reference string to create a higher-level aggregated proof. The subsequent prover entity may add the newly created higher-level proof to the set of proofs at the next level in the hierarchy. The subsequent prover entity may store the merged proofs in the memory for subsequent processing and verification operations. The subsequent prover entity may output, via an electronic interface, the merged proofs as a new proof Πᵢ₊₁ for transmission to additional prover entities or the verifier entity.

With continued reference to FIG. 5, the verifier entity comprising at least one computerized processor and memory and in electronic communication with the prover entity may perform final verification of the distributed computation. The verifier entity may receive, via an electronic interface, the combined common reference string ers from the setup entity. The verifier entity may receive, via an electronic interface, inputs (x₀, xₜ, t) representing the initial state, final state, and total computation steps, along with a proof Πₜ from the final prover entity. The verifier entity may verify, using the at least one processor, proofs at each level of the hierarchy using the corresponding seBARG and SNARG verification algorithms. The verification process may traverse the hierarchical proof structure, checking the validity of aggregated proofs at higher levels and individual computation steps at the base level. The verifier entity may output, via an electronic interface, a verification result indicating whether the distributed computation has been successfully verified across all participating entities.

The standard verification method may provide computational efficiency by eliminating cryptographic overhead associated with zero-knowledge protocols while maintaining verification integrity through hierarchical proof aggregation. The method may enable scalable distributed computation verification by allowing multiple prover entities to participate in the verification process without requiring complex coordination mechanisms beyond proof transmission and verification operations.

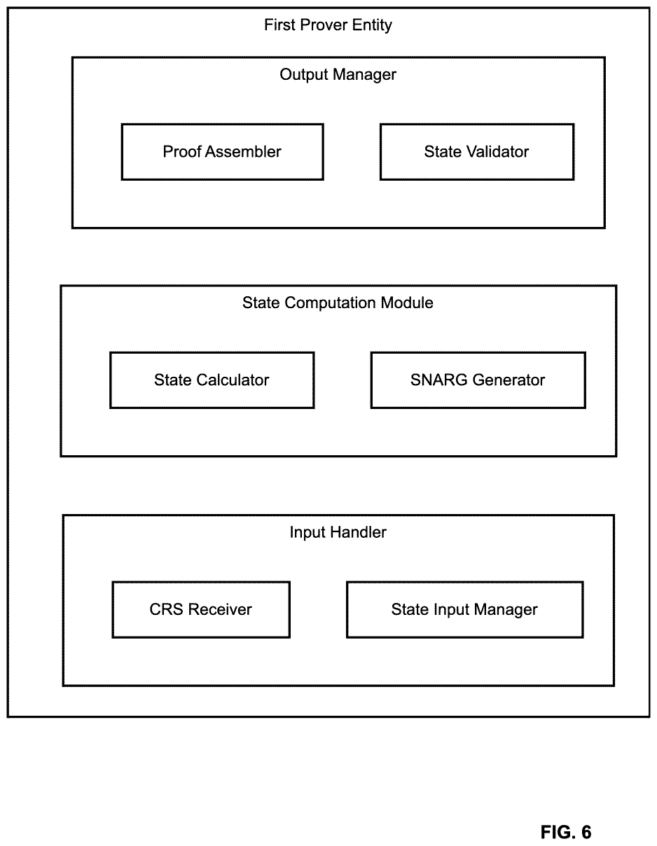

Referring to FIG. 6, a first prover entity may be implemented as a computerized system comprising a hierarchical architecture designed to process distributed computation verification tasks. The first prover entity may include a computerized processor and a memory storing instructions that, when executed by the processor, cause the first prover entity to perform various computational and cryptographic operations.

The first prover entity system may comprise three main modules arranged in a hierarchical structure: an Output Manager, a State Computation Module, and an Input Handler. The Input Handler may be positioned at the foundational level of the architecture and may include a CRS Receiver and a State Input Manager. The CRS Receiver may be configured to process incoming common reference strings, including the combined common reference string ers received from a setup entity. In some cases, the CRS Receiver may validate the format and integrity of the received common reference string crs before passing the string to other system components.

The State Input Manager may be configured to handle state-related inputs, including starting configurations and witnesses. In some cases, the State Input Manager may receive inputs x₀ and a witness w₀ as part of the initial computation parameters. The State Input Manager may validate the format and consistency of these inputs before forwarding them to higher-level processing modules. The Input Handler may perform preliminary validation checks to ensure that received data conforms to expected formats and cryptographic requirements.

As shown in FIG. 6, the State Computation Module may be positioned above the Input Handler in the hierarchical structure and may include a State Calculator and a SNARG Generator. The State Calculator may be configured to perform computational operations on received state data and witnesses. In some cases, the State Calculator may compute a new state x₁=C(x₀, w₀) by applying a computation function C to the starting configuration x₀ and witness w₀. The computation function C may represent a deterministic state transition that transforms the input configuration into a subsequent configuration based on the provided witness.

The SNARG Generator may be configured to create succinct non-interactive arguments for computed state transitions. In some cases, the SNARG Generator may generate a SNARG proof π_{SNARG} at level 0 using crs_{SNARG} for the state pair (x₀, x₁) with witness to. The SNARG proof may provide cryptographic evidence that the state transition from x₀ to x₁ was performed correctly according to the specified computation function. The SNARG Generator may utilize the SNARG portion of the combined common reference string ers to construct the proof structure.

With continued reference to FIG. 6, the Output Manager may be positioned at the top level of the hierarchical architecture and may contain a Proof Assembler and a State Validator. The Proof Assembler may be configured to combine various proof components and state information into a cohesive output structure. In some cases, the Proof Assembler may assemble the generated SNARG proof π_{SNARG} along with associated state information to create a complete proof package. The assembled proof may be formatted as Π₁, representing the first prover's contribution to the distributed computation verification process.

The State Validator may be configured to perform validation checks on computed states and generated proofs before final output. In some cases, the State Validator may verify that the computed state x₁ corresponds correctly to the applied computation function and that the generated SNARG proof maintains cryptographic soundness. The State Validator may also check consistency between the input parameters, computed results, and proof structures to ensure system integrity.

The modular architecture shown in FIG. 6 may enable parallel processing capabilities within each hierarchical level. The components within each module may be positioned to allow concurrent operations, with the CRS Receiver and State Input Manager operating simultaneously within the Input Handler, the State Calculator and SNARG Generator processing data concurrently within the State Computation Module, and the Proof Assembler and State Validator working in parallel within the Output Manager.

The first prover entity may output the assembled proof Π₁ for transmission to subsequent entities in the distributed computation verification system. The output may include the SNARG proof π_{SNARG} along with any associated metadata or state information needed for verification by downstream components. The hierarchical organization of the first prover entity may provide clear separation between input handling, state computation, and output management functions, enabling efficient processing of distributed computation tasks while maintaining cryptographic security properties.

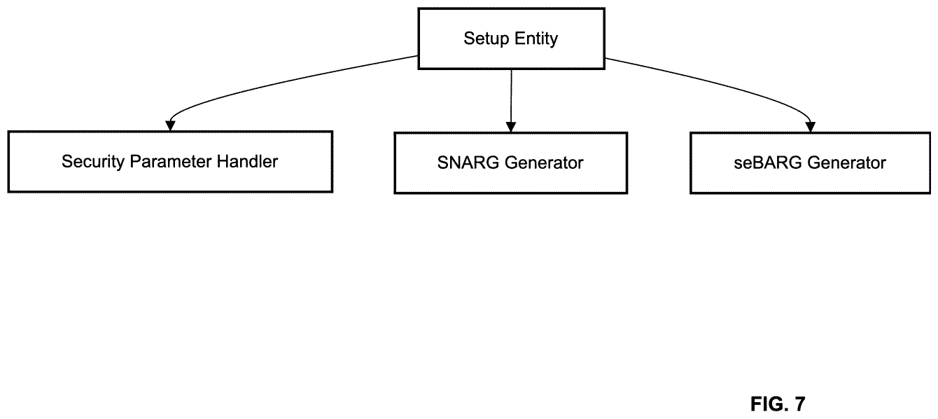

Referring to FIG. 7, a Setup Entity system may be configured to coordinate the generation of cryptographic parameters and reference strings for distributed computation verification. The Setup Entity system may comprise a hierarchical architecture with a Setup Entity module positioned at the top level that connects to three subordinate modules through directional connections. The Setup Entity module may control and coordinate the operations of a Security Parameter Handler, a SNARG Generator, and a seBARG Generator, with directional arrows indicating the flow of information from the Setup Entity to each specialized component.

The Security Parameter Handler may receive and process security-related parameters for the system. In some cases, the Security Parameter Handler may receive security parameters ( [symbol] , T), where) represents a security parameter and T represents an iteration bound. The Security Parameter Handler may validate these security parameters to ensure proper system configuration. The Security Parameter Handler may calculate [symbol] ₘₐₓ as a base-2 logarithm of T rounded up to the nearest integer as a representation of the maximum level of the proof hierarchy. This calculation may determine the depth of the hierarchical proof structure that the system can support.

The SNARG Generator may create succinct non-interactive arguments for the verification system. As shown in FIG. 7, the SNARG Generator may receive control signals from the Setup Entity module and may generate a succinct non-interactive argument (SNARG) common reference string crs_{SNARG} for a language L_{SNARG}. The language L_{SNARG} may contain all tuples (x₀, x₁) such that there exists a witness w such that C(x₀, w)=x₁, where C represents the distributed computation and x₀ and x₁ represent consecutive configurations in the computation sequence. The SNARG Generator may produce reference strings that enable the creation of succinct proofs for valid state transitions between configurations.

The seBARG Generator may produce somewhere extractable batch argument reference strings for multiple hierarchy levels. With continued reference to FIG. 7, the seBARG Generator may enable proof batching and merging capabilities across different levels of the verification hierarchy. The seBARG Generator may generate a rate-1 somewhere extractable batch argument (seBARG) common reference string crs₁ for the language that contains all tuples (x₀, ⊥, x₁) for which there exists a SNARG proof π_{SNARG} that (x₀, x₁) is in L_{SNARG}. The symbol ⊥ may represent a placeholder or null value in the tuple structure.

The seBARG Generator may generate a series of rate-1 somewhere extractable batch argument (seBARG) common reference strings { [symbol] } where for each level [symbol] , the seBARG may be configured for the language that contains tuples (x₀, x₁, x₂). For each tuple (x₀, x₁, x₂) in the language, there may exist (x_{L}, π_{L}) and (x_{R}, π_{R}) such that π_{L} represents a previous level seBARG for (x₀, x_{L}, x₁) and π_{R} represents a previous level seBARG for (x₁, x_{R}, x₂). This hierarchical structure may enable the aggregation of proofs from lower levels into higher-level batch arguments.

The Setup Entity system may output a combined common reference string crs:=(crs_{SNARG}, { [symbol] ) that encompasses all generated reference strings. The combined common reference string may provide the cryptographic parameters for the distributed computation verification system. The Setup Entity module may coordinate the generation process by directing each subordinate module to perform specific functions while maintaining the overall system architecture and ensuring proper parameter generation across all hierarchy levels.

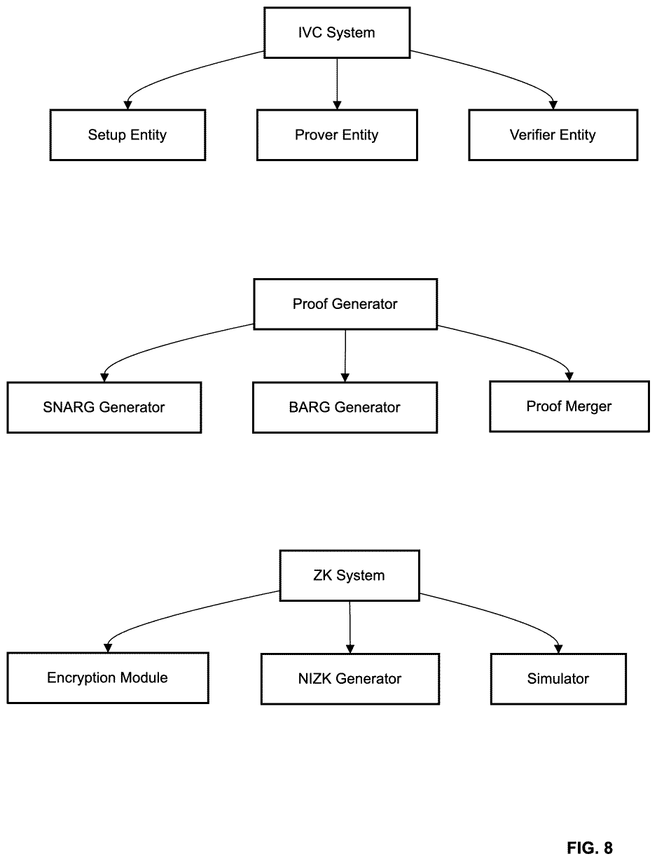

Referring to FIG. 8, the integrated system architecture demonstrates a comprehensive framework for distributed computation verification through three interconnected system components. The IVC System may contain a Setup Entity, a Prover Entity, and a Verifier Entity that work in coordination to establish and maintain the verification infrastructure. The Setup Entity may initialize system parameters and generate the combined common reference string ers that serves as a foundation for subsequent proof operations. The Prover Entity may include both first prover entities and subsequent prover entities that participate in the distributed computation process.

A subsequent prover entity may be in communication with both the setup entity and the first prover entity or a previous prover entity. The subsequent prover entity may comprise a computerized processor and a memory storing instructions that, when executed by the processor, cause the subsequent prover entity to perform verification and computation operations. The subsequent prover entity may receive the combined common reference string crs from the setup entity, enabling the entity to access the cryptographic parameters needed for proof generation and verification.

The subsequent prover entity may receive inputs (x₀, xᵢ, i), a proof Πᵢ, and a witness wᵢ from either the first prover entity or a previous prover entity in the computation chain. The inputs may represent the initial state x₀, the current state xᵢ, and an index i indicating the position in the computation sequence. The proof Πᵢ may represent a cryptographic proof demonstrating the validity of the computation path from the initial state to the current state.

As shown in FIG. 8, the subsequent prover entity may verify Πᵢ is a proof for (x₀, xᵢ, i) using the same method as the verifier entity. This verification process may ensure that the received proof accurately represents the computation history before proceeding with additional computation steps. The verification may utilize the cryptographic parameters contained within the combined common reference string crs to validate the proof structure and mathematical relationships.

Following successful verification, the subsequent prover entity may compute a new state xᵢ₊₁=C(xᵢ, wᵢ) where C represents the computation function that transforms the current state xᵢ using the witness wᵢ. This computation may advance the distributed computation by one step, creating a new state that reflects the application of the witness to the previous state.

The Proof Generator system may comprise a SNARG Generator, a BARG Generator, and a Proof Merger that facilitate the creation and combination of cryptographic proofs. The SNARG Generator may create succinct non-interactive arguments for individual computation steps, while the BARG Generator may produce batch arguments that aggregate multiple proof elements. The Proof Merger may combine proofs from different levels of the hierarchical structure, enabling the system to create compact representations of extended computation sequences.

With continued reference to FIG. 8, the ZK System may incorporate an Encryption Module, a NIZK Generator, and a Simulator to maintain zero-knowledge properties throughout the verification process. The Encryption Module may encrypt state information to preserve privacy while enabling verification operations. The NIZK Generator may create non-interactive zero-knowledge proofs that demonstrate computational validity without revealing sensitive information. The Simulator may generate simulated proofs for security analysis and system validation.

The interactions between systems may occur through standardized interfaces that enable seamless communication and data exchange. The IVC System may coordinate with the Proof Generator for proof creation and merging operations, requesting specific types of proofs based on the current computation state and verification requirements. The ZK System may provide encryption and zero-knowledge capabilities to both the IVC System and the Proof Generator, ensuring that privacy properties are maintained throughout the distributed computation process.

The hierarchical organization may facilitate systematic proof generation through a structured approach to computation verification. The Setup Entity may initialize parameters that are utilized by both the Proof Generator and the ZK System, establishing a consistent cryptographic foundation across all system components. The Proof Generator may create proofs using encrypted states provided by the ZK System, ensuring that computational validity can be demonstrated without compromising data privacy.

The Verifier Entity may perform final verification operations by coordinating with both the Proof Generator and the ZK System. The verification process may validate proofs generated by the Proof Generator while utilizing zero-knowledge properties maintained by the ZK System. This integrated approach may enable comprehensive verification that encompasses both computational correctness and privacy preservation.

The modular architecture shown in FIG. 8 may enable flexible deployment configurations where different system components can be distributed across multiple computing environments. The standardized interfaces between systems may facilitate scalability by allowing individual components to be replicated or enhanced without affecting the overall system functionality. The separation of concerns between proof generation, zero-knowledge operations, and verification coordination may enable specialized optimization of each system component.

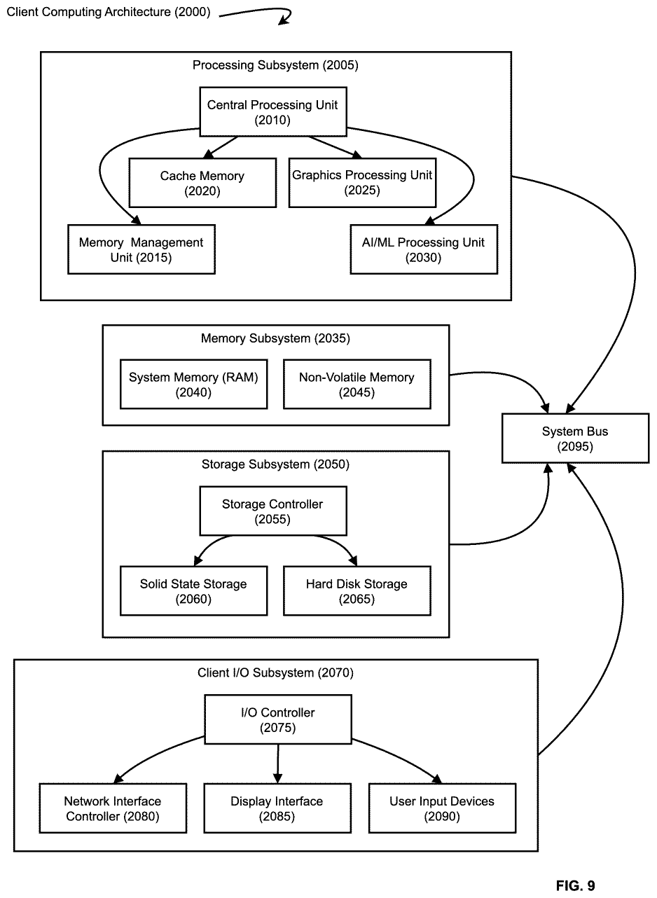

Referring to FIG. 9, a Client Computing Architecture 2000 may be configured to execute distributed computation verification operations through coordinated subsystem interactions. The Client Computing Architecture 2000 may comprise multiple interconnected subsystems that work together to process cryptographic proofs, manage verification data, and facilitate communication with distributed computing networks.

The Client Computing Architecture 2000 may include a Processing Subsystem 2005 that serves as the computational core for verification operations. The Processing Subsystem 2005 may contain a Central Processing Unit 2010 positioned at the top of the subsystem hierarchy. The Central Processing Unit 2010 may execute verification algorithms, coordinate proof generation processes, and manage computational workflows for incrementally verifiable computation systems. In some cases, the Central Processing Unit 2010 may process SNARG proofs, BARG proofs, and hierarchical proof structures as described in the verification methods.

The Processing Subsystem 2005 may further include a Cache Memory 2020 that provides high-speed temporary storage for frequently accessed cryptographic parameters and intermediate computation results. The Cache Memory 2020 may store common reference strings, verification keys, and proof data to reduce memory access latency during verification operations. In some cases, the Cache Memory 2020 may maintain cached copies of SNARG common reference strings and seBARG parameters to accelerate proof verification processes.

A Graphics Processing Unit 2025 may be positioned within the Processing Subsystem 2005 to provide parallel processing capabilities for computationally intensive cryptographic operations. The Graphics Processing Unit 2025 may execute parallel verification algorithms, perform batch proof processing, and accelerate mathematical computations associated with zero-knowledge proof systems. In some cases, the Graphics Processing Unit 2025 may process multiple SNARG proofs simultaneously or perform parallel operations on hierarchical proof structures.

The Processing Subsystem 2005 may also contain a Memory Management Unit 2015 that manages memory allocation and access patterns for verification operations. The Memory Management Unit 2015 may coordinate memory usage between different processing components, manage virtual memory addressing for large proof datasets, and optimize memory access patterns for cryptographic computations. In some cases, the Memory Management Unit 2015 may handle memory mapping for encrypted states and proof data structures.

An AI/ML Processing Unit 2030 may be included within the Processing Subsystem 2005 to provide specialized processing capabilities for machine learning-enhanced verification operations. The AI/ML Processing Unit 2030 may execute optimization algorithms for proof generation, perform pattern recognition on computation traces, and implement adaptive verification strategies. In some cases, the AI/ML Processing Unit 2030 may optimize proof merging operations or predict optimal hierarchical proof structures based on computation patterns.

With continued reference to FIG. 9, the Client Computing Architecture 2000 may include a Memory Subsystem 2035 positioned below the Processing Subsystem 2005. The Memory Subsystem 2035 may provide primary storage for active verification operations and temporary data structures. The Memory Subsystem 2035 may contain a System Memory (RAM) 2040 that stores active proof data, verification algorithms, and intermediate computation results during verification processes. The System Memory (RAM) 2040 may maintain encrypted states, witness data, and configuration information for distributed computation verification.

The Memory Subsystem 2035 may also include a Non-Volatile Memory 2045 that provides persistent storage for cryptographic parameters and verification keys. The Non-Volatile Memory 2045 may store common reference strings, public keys for encryption schemes, and NIZK parameters that persist across system restarts. In some cases, the Non-Volatile Memory 2045 may maintain backup copies of verification data and provide secure storage for sensitive cryptographic material.

The Client Computing Architecture 2000 may further comprise a Storage Subsystem 2050 positioned below the Memory Subsystem 2035. The Storage Subsystem 2050 may provide long-term storage capabilities for proof archives, verification logs, and historical computation data. The Storage Subsystem 2050 may include a Storage Controller 2055 positioned at the top of the subsystem that manages storage operations and coordinates data access across multiple storage devices.

The Storage Subsystem 2050 may contain a Solid State Storage 2060 that provides high-speed persistent storage for frequently accessed verification data and proof archives. The Solid State Storage 2060 may store recent proof histories, active verification datasets, and performance-sensitive cryptographic parameters. In some cases, the Solid State Storage 2060 may maintain indexed proof databases and provide rapid access to verification results.

A Hard Disk Storage 2065 may be positioned within the Storage Subsystem 2050 to provide high-capacity storage for comprehensive proof archives and long-term verification logs. The Hard Disk Storage 2065 may store complete computation histories, archived proof chains, and backup verification data. In some cases, the Hard Disk Storage 2065 may maintain distributed computation audit trails and provide storage for compliance and verification purposes.

As further shown in FIG. 9, the Client Computing Architecture 2000 may include a Client I/O Subsystem 2070 positioned at the bottom of the architecture. The Client I/O) Subsystem 2070 may manage communication interfaces and user interaction capabilities for distributed computation verification. The Client I/O) Subsystem 2070 may contain an I/O Controller 2075 positioned at the top of the subsystem that coordinates input/output operations and manages data flow between internal subsystems and external interfaces.

The Client I/O Subsystem 2070 may include a Network Interface Controller 2080 that provides network connectivity for distributed computation verification operations. The Network Interface Controller 2080 may facilitate communication with other verification entities, transmit proof data across distributed networks, and receive computation results from remote processing nodes. In some cases, the Network Interface Controller 2080 may implement secure communication protocols for transmitting encrypted states and verification proofs.

A Display Interface 2085 may be positioned within the Client I/O Subsystem 2070) to provide visual output capabilities for verification operations and system status information. The Display Interface 2085 may render verification results, display proof generation progress, and present system performance metrics. In some cases, the Display Interface 2085 may provide graphical representations of hierarchical proof structures and verification workflows.

The Client I/O Subsystem 2070 may also contain User Input Devices 2090 that enable user interaction with the verification system. The User Input Devices 2090 may receive user commands for initiating verification operations, accept configuration parameters for proof generation, and provide control interfaces for distributed computation management. In some cases, the User Input Devices 2090 may allow users to specify verification parameters and monitor proof generation processes.

The Client Computing Architecture 2000 may include a System Bus 2095 positioned on the right side of the architecture that provides bidirectional communication pathways connecting all subsystems. The System Bus 2095 may enable coordinated data flow between the Processing Subsystem 2005, Memory Subsystem 2035, Storage Subsystem 2050, and Client I/O) Subsystem 2070. The System Bus 2095 may facilitate the transfer of proof data, verification results, and control signals throughout the Client Computing Architecture 2000.

The System Bus 2095 may support high-bandwidth data transfers for large proof datasets and provide low-latency communication for time-sensitive verification operations. In some cases, the System Bus 2095 may implement priority-based data routing to ensure that verification operations receive appropriate system resources and maintain optimal performance during distributed computation verification processes.

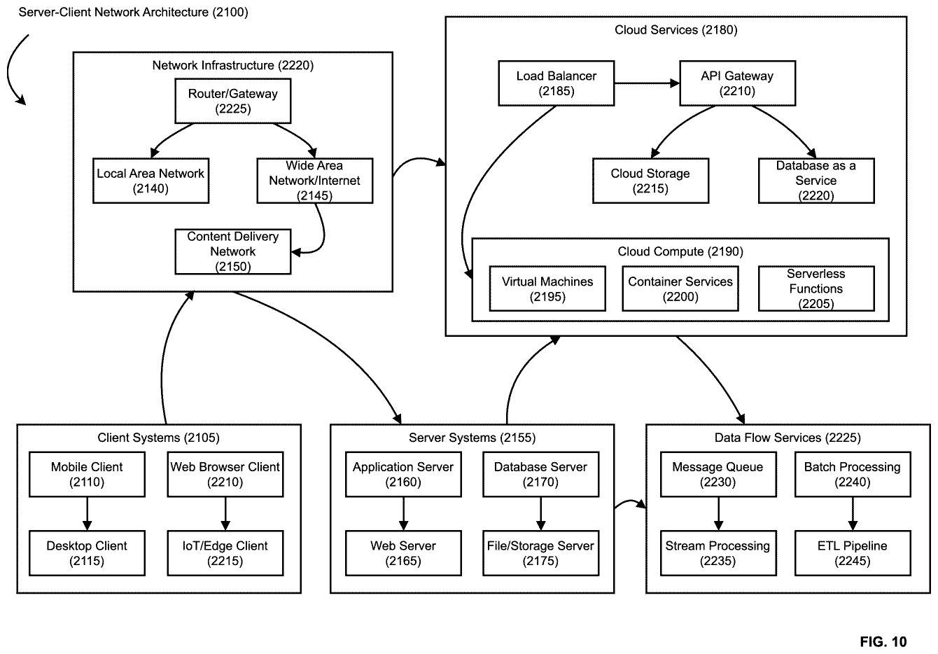

Referring to FIG. 10, a server-client network architecture 2100 may be implemented to support distributed computation verification operations across multiple computing environments. The server-client network architecture 2100 may provide a comprehensive framework for executing hierarchical proof generation and verification processes in distributed computing scenarios.

Client systems 2105 may comprise various computing devices configured to access computational resources and participate in distributed verification operations. A mobile client 2110) may include smartphones, tablets, or other portable computing devices capable of generating or verifying cryptographic proofs. A desktop client 2115 may encompass traditional personal computers, workstations, or other stationary computing systems with enhanced processing capabilities for handling complex verification tasks. The client systems 2105 may initiate proof generation requests, submit computational tasks, and receive verification results through network connections.

The network infrastructure may facilitate communication between distributed components of the verification system. A local area network 2140) may connect client systems 2105 within a localized geographic area, providing high-speed communication for proof generation and verification operations. A wide area network 2145 may extend connectivity across broader geographic regions, enabling distributed provers and verifiers to collaborate on large-scale computational verification tasks. A content delivery network 2150 may optimize the distribution of cryptographic parameters, proof data, and verification results across multiple network nodes, reducing latency and improving system performance.

Server systems 2155 may provide core computational and data management capabilities for the distributed verification framework. An application server 2160 may execute proof generation algorithms, coordinate distributed computation tasks, and manage the hierarchical merging of SNARG and BARG proofs. A web server 2165 may handle client requests, serve verification interfaces, and facilitate communication between different system components. The application server 2160) may connect to the web server 2165 to provide seamless integration between computational processes and user interfaces.

A database server 2170 may store cryptographic parameters, proof data, computation states, and verification results in a structured format. A file storage server 2175 may manage large-scale storage of proof hierarchies, encrypted states, and computational witnesses. The database server 2170) may connect to the file storage server 2175 to provide coordinated data management across different storage systems, enabling efficient retrieval of proof components during verification operations.

Cloud services 2180 may extend the distributed verification system with scalable computational and storage resources. A load balancer 2185 may distribute incoming proof generation and verification requests across multiple processing nodes, preventing system bottlenecks and maintaining consistent performance. The load balancer 2185 may connect to an API gateway 2210, which may serve as a centralized entry point for accessing cloud-based verification services.

Cloud compute 2190) may provide flexible computational resources for executing proof generation algorithms across different deployment models. Virtual machines 2195 may offer isolated computing environments for running SNARG generation, BARG merging, and verification processes. Container services 2200 may enable lightweight deployment of proof generation components, facilitating rapid scaling of verification operations. Serverless functions 2205 may execute specific cryptographic operations on-demand, reducing resource overhead and enabling cost-effective processing of verification tasks.

The API gateway 2210) may manage access control, request routing, and service orchestration for cloud-based verification operations. Cloud storage 2215 may provide scalable storage solutions for proof hierarchies, cryptographic parameters, and computation results. Database as a service 2220 may offer managed database functionality for storing and retrieving verification data without requiring dedicated database administration.

Data flow services 2225 may enable asynchronous processing and transformation of verification data across the distributed system. A message queue 2230) may facilitate communication between distributed provers, enabling coordination of proof generation tasks and hierarchical merging operations. The message queue 2230 may connect to stream processing 2235, which may handle real-time processing of proof data and verification results as the data flows through the system.

Batch processing 2240) may execute large-scale verification operations on accumulated proof data, enabling efficient processing of multiple verification tasks simultaneously. An ETL pipeline 2245 may extract proof data from various sources, transform the data into appropriate formats for verification, and load the processed data into storage systems. The batch processing 2240) may connect to the ETL pipeline 2245 to coordinate data transformation and verification workflows.

The server-client network architecture 2100 may support bidirectional data flow between components, enabling collaborative proof generation and verification across distributed computing environments. The content delivery network 2150 may connect to both network infrastructure components and cloud services 2180, facilitating efficient distribution of cryptographic parameters and proof data across the distributed system. The server systems 2155 may connect to the cloud compute 2190) subsystem, enabling hybrid deployment models where traditional server infrastructure may be augmented with cloud-based computational resources for handling peak verification loads.

Throughout this disclosure, various terms and phrases are used to describe features of the disclosed technology. It is to be understood that these terms and phrases may encompass a variety of meanings and definitions, as is common in the field of technology and patent law. The definitions of these terms may vary depending on the context in which they are used, the specific embodiment being described, or the interpretation of the technology by those skilled in the art.

In various embodiments, certain variable names, symbols, or labels may be used in the claims to represent various elements, components, or steps of the described methods, systems, and apparatuses. These variable names, symbols, or labels are provided for convenience and clarity in describing the claimed subject matter. However, it should be understood that the use of such variable names, symbols, or labels in the claims does not necessarily limit these elements, components, or steps to being the same specific entities described in the specification or in other parts of the disclosure. The variable names, symbols, or labels used in the claims should be interpreted broadly and may encompass various implementations, variations, or equivalents of the described elements, components, or steps, unless explicitly stated otherwise or clearly limited by the context of the claim. As such, the scope of the claims is not confined to the specific examples or embodiments described in the specification, but rather extends to the full breadth of the inventive concepts disclosed herein.

For instance, terms such as “computing device,” “processor,” “memory,” and “network” may refer to a wide range of devices, components, systems, and configurations known in the art, and their specific definitions may differ based on the implementation or design of the system. Similarly, phrases like “securely storing,” “computing a vector,” and “generating a message” may involve various methods, techniques, and processes that achieve the same or similar outcomes but may be executed in different manners.

It is also to be understood that the use of terms in the singular or plural form is not intended to limit the scope of the claims. For example, the mention of “a computing device” does not preclude the presence of multiple computing devices within a system. Likewise, references to “a network” may include various interconnected networks or a single network comprising multiple segments or layers.

Furthermore, the use of the term “may” in relation to an action or feature indicates that the action or feature is possible, but not necessarily mandatory. This term is used to describe optional or alternative aspects of the disclosed technology that provide flexibility in how the technology may be implemented or utilized.

The definitions provided herein are intended to serve as examples and are not exhaustive. Those skilled in the art may ascribe different meanings to these terms based on the context, the specific technology being described, or the advancements in the field. Therefore, the definitions of the terms and phrases used in this disclosure and the claims are to be interpreted broadly and in a manner consistent with the understanding of those skilled in the relevant art.

The use of the word “a” or “an” when used in conjunction with the claims herein is to be interpreted as including one or more than one of the element it introduces. Similarly, the use of the term “or” is intended to be inclusive, such that the phrase “A or B” is intended to include A, B, or both A and B, unless explicitly stated otherwise.

Reference throughout the specification to “one embodiment,” “another embodiment,” “an embodiment,” and so forth, means that a particular feature, structure, or characteristic described in connection with the embodiment is included in at least one embodiment of the present disclosure, and may not necessarily be present in all embodiments. Furthermore, the particular features, structures, or characteristics may be combined in any suitable manner in one or more embodiments without limitation.

The use of the terms “first,” “second,” and the like does not imply any order or sequence, but are used to distinguish one element from another, and the terms “top,” “bottom,” “front,” “back,” “leading,” “trailing,” and the like are used for descriptive purposes and are not necessarily to be construed as limiting.

As used herein, the term “processor” refers to any computing entity capable of executing instructions to perform a specific set of operations, whether implemented in hardware, firmware, software, or any combination thereof. This definition includes a broad range of processing technologies and architectures. The term encompasses general-purpose processors such as Central Processing Units (CPUs), specialized processors such as Graphics Processing Units (GPUs), as well as highly specialized hardware accelerators such as Neural Processing Units (NPUs) for artificial intelligence applications and Tensor Processing Units (TPUs) for machine learning workloads.

The term also encompasses reconfigurable computing architectures such as Field-Programmable Gate Arrays (FPGAs) for applications requiring specialized processing configurations, Application-Specific Integrated Circuits (ASICs), Digital Signal Processors (DSPs), Systolic Array Processors, and emerging computing paradigms such as Quantum Processors that leverage principles of quantum mechanics. System on Chip (SoC) designs, heterogeneous computing systems, Edge Computing Processors for distributed network applications, cloud-based and distributed processors, multicore and parallel processors, and Neuromorphic processors that draw inspiration from biological neural architectures are all encompassed within this definition.

The term “processor” also encompasses the associated memory hierarchies, including primary memory (such as RAM), secondary storage (such as hard drives and SSDs), and cache memory, which work in conjunction with the processor to store and retrieve data necessary for executing instructions. In this patent application, any reference to a “processor” should be interpreted broadly to include any type of processing unit capable of performing the described functions, regardless of its specific implementation, architecture, or physical form.

As used herein, the term “messages” may refer to any form of data or information that can be processed, transmitted, or stored in a digital format. Messages may include arbitrary-length plaintext messages, pre-hashed messages, concatenated messages, binary data, network protocol messages, database records, and time-stamped messages. Messages may be composed of characters, symbols, or binary data and may represent various forms of content such as text, numbers, multimedia, executable code, or any other data that can be digitally encoded. Messages may be used as input for cryptographic functions, such as keyed hash functions, where they are transformed into a fixed-size hash value influenced by a secret cryptographic key.

The term “messages” encompasses a wide range of data types and structures, from simple text strings to complex structured data, and may include metadata, headers, footers, or other information that facilitates the processing, transmission, or interpretation of the content. Messages may be generated by users, systems, or processes and may be intended for various purposes, including communication, authentication, verification, logging, or any other function that involves the use of digital data.

Messages may also include data formats specific to artificial intelligence and machine learning applications, such as tensors, feature vectors, embeddings, model parameters, activation maps, training examples, and inference requests. In distributed and edge computing contexts, the term “messages” further extends to include event streams, state updates, service requests, synchronization messages, and smart contract transactions used in blockchain platforms.

As used herein, the terms “store,” “storing,” “storage,” or variants thereof refer to any means, methods, systems, or processes for recording, retaining, or preserving data in a retrievable format. This terminology encompasses a broad spectrum of technologies and mechanisms that may be employed to maintain information for future access or reference.

The term “storing” or “storage” as used in this specification may encompass both persistent and transient data retention. In some cases, the storage may be entirely ephemeral, lasting only for the duration of a specific operation or process. The use of these terms does not imply any particular time period for data retention or any level of permanence. Storage and storing may be as brief as a few microseconds or indefinitely long, depending on the specific implementation and requirements of the system.

The term includes traditional electronic storage technologies such as magnetic storage (including hard disk drives, magnetic tape, and floppy disks), optical storage (including optical discs, holographic storage, and optical tape), and solid-state storage (including solid-state drives, flash memory, static random-access memory, dynamic random-access memory, and read-only memory). It also encompasses emerging storage technologies such as DNA storage, molecular storage, quantum storage, and photonic storage.

Storage terminology may refer to various architectural organizations and hierarchies of data repositories. This includes primary storage (main memory, cache memory) designed for rapid access during processing operations; secondary storage providing non-volatile retention of larger data volumes; and tertiary storage for archival purposes. The terminology extends to distributed storage architectures such as network-attached storage (NAS), storage area networks (SAN), direct-attached storage (DAS), and object storage systems. It also includes cloud-based storage configurations, including public, private, and hybrid cloud storage implementations; edge storage systems located at network peripheries; and fog storage systems distributed between centralized and edge locations.

The definition encompasses storage virtualization technologies that abstract physical storage resources and present them as logical storage units, including virtual disks, software-defined storage, and storage hypervisors. It also includes storage orchestration systems that manage data placement, replication, and migration across distributed infrastructures.

The terminology extends to various data organization and management paradigms. This includes file systems that organize data into files and directories; block storage systems that manage data as fixed-sized blocks; object storage systems that handle data as discrete objects with metadata; and content-addressable storage systems that retrieve data based on content rather than location. It also includes specialized storage structures such as databases, data lakes, data warehouses, and knowledge repositories.

Storage terminology encompasses various operational characteristics and capabilities of storage systems. This includes persistent storage that maintains data integrity across power cycles; volatile storage that requires continuous power to retain data; and non-volatile storage that preserves data without power. It also includes immutable storage that prevents modification of stored data; append-only storage that allows additions but not modifications; and version-controlled storage that maintains historical states of data. The term further encompasses encrypted storage that protects data confidentiality; redundant storage that duplicates data to prevent loss; and resilient storage that maintains availability despite component failures.

In specialized computing contexts, storage terminology may refer to domain-specific storage mechanisms. For blockchain and distributed ledger technologies, this includes on-chain storage within the blockchain itself and off-chain storage that maintains references to externally stored data. For neural networks and artificial intelligence systems, it includes weight storage for maintaining learned parameters and activation storage for intermediate computational results. For quantum computing systems, it refers to quantum state storage that preserves quantum information, while for edge computing, it includes transient storage for temporary data processing at network boundaries.

The term “storage” also encompasses the protocols, interfaces, and access methods used to interact with stored data. This includes file access protocols (such as NFS, SMB, and HDFS), block access protocols (such as iSCSI, Fibre Channel, and ATA), and object access protocols (such as S3, Swift, and CDMI). It also includes direct memory access mechanisms, memory-mapped file interfaces, and storage controller interfaces.

The term “database” should be construed to mean a blockchain, distributed ledger technology, key-value store, document-oriented database, graph database, time-series database, in-memory database, columnar database, object-oriented database, hierarchical database, network database, or any other structured data storage system capable of storing and retrieving information. This may include traditional relational database management systems (RDBMS), NoSQL databases, NewSQL databases, or hybrid database systems that combine multiple database paradigms. The database may be centralized, distributed, or decentralized, and may employ various data models, indexing strategies, and query languages to organize and access the stored information. It may also incorporate features such as ACID (Atomicity, Consistency, Isolation, Durability) compliance, eventual consistency, sharding, replication, or partitioning to ensure data integrity, availability, and scalability. The database may be hosted on-premises, in the cloud, or in a hybrid environment, and may support various access methods including direct queries, API calls, or event-driven architectures.

The term “database” further encompasses specialized data storage and management systems designed for particular domains or use cases. This includes blockchain and distributed ledger technologies used for secure, decentralized transaction records, edge databases optimized for resource-constrained environments, vector databases for high-dimensional data, time-series databases for temporal data management, knowledge graphs for representing interconnected information, federated databases for integrating autonomous systems, and emerging paradigms such as quantum databases that leverage quantum computing principles.

The terms “connected,” “coupled,” or any variant thereof, mean any direct or indirect connection or coupling between two or more elements, and may encompass the presence of one or more intermediate elements between the two elements that are connected or coupled to each other.

In the context of modern computing architectures and network topologies, these terms may also refer to various connection modalities. This includes physical connections through wired or wireless interfaces, logical connections operating independently of the physical layer, API connections allowing software components to communicate, and microservice connections in distributed architectures. The terminology extends to edge-to-cloud connections for distributed processing environments, blockchain connections for distributed ledger systems, quantum connections for secure communication, and neural network connections for artificial intelligence systems.

As used herein, the term “display” or “displaying” refers to any means, method, apparatus, or process for visually presenting or otherwise conveying information to a user. This terminology encompasses a broad spectrum of technologies and presentation modalities that may be employed to render content perceivable by a user. The term includes traditional display technologies such as cathode ray tubes (CRTs), liquid crystal displays (LCDs), light-emitting diode (LED) displays, organic light-emitting diode (OLED) displays, micro-LED displays, and electronic paper displays. It also encompasses specialized display types such as transparent displays, flexible displays, foldable displays, stretchable displays, and holographic displays.

The term “display” may also refer to projection systems, including traditional projectors, laser projectors, pico projectors, and holographic projection systems. It further includes immersive display technologies such as head-mounted displays (HMDs), virtual reality (VR) headsets, augmented reality (AR) glasses, mixed reality (MR) systems, and smart contact lenses. The terminology extends to ambient display methods that integrate visual information into the environment, such as smart mirrors, interactive surfaces, projection mapping systems, and volumetric displays.

The definition also encompasses non-visual display modalities that may complement or substitute for visual displays. This includes auditory displays such as speech output systems, sonification interfaces, and spatial audio; haptic displays that communicate through tactile feedback, vibration patterns, or force feedback; and other sensory output mechanisms such as olfactory displays and thermotactile interfaces. Multimodal displays that combine multiple sensory channels for information presentation are also included within this terminology.

The term “display” further encompasses the software and computational components involved in rendering information. This includes rendering engines, graphics processing pipelines, display servers, and compositing systems. It also includes specialized display rendering techniques such as rasterization, ray tracing, vector graphics, procedural generation, and neural rendering. The term extends to user interface paradigms such as graphical user interfaces (GUIs), natural user interfaces (NUIs), voice user interfaces (VUIs), brain-computer interfaces (BCIs), and ambient intelligence systems.

In the context of accessibility, the term “display” includes assistive technologies and alternative display methods designed to accommodate diverse user needs. This encompasses screen readers, braille displays, audio descriptions, high-contrast modes, color-shifted presentations, and other adaptive display mechanisms. The terminology also includes display personalization techniques such as adaptive interfaces, contextual displays, and user-specific rendering optimizations.

The description of the embodiments of the present disclosure is intended to be illustrative, and not to limit the scope of the claims. Many alternatives, modifications, and variations will be apparent to those skilled in the art. A number of implementations have been described. Nevertheless, it will be understood that various modifications may be made without departing from the spirit and scope of the disclosure. Accordingly, other implementations are within the scope of the following claims.

1. A method for verifying the execution of any distributed computation C across multiple untrusted nodes starting from a configuration x₀, wherein each node computes from the previous configuration xᵢ the next configuration xᵢ₊₁ dependent on C and a nondeterministic input wᵢ, the method comprising:
(a) at a setup entity comprising at least one computerized processor and memory:
(i) receiving, via an electronic interface, security parameters ( [symbol] , T), where λ is a security parameter, and T is an iteration bound;
(ii) calculating, using the at least one processor, [symbol] ₘₐₓ as a base-2 logarithm of T rounded up to the nearest integer as a representation of the maximum level of the proof hierarchy;
(iii) generating, using the at least one processor, a succinct non-interactive argument (SNARG) common reference string crs_{SNARG} for a language L_{SNARG} that contains all tuples (x₀, x₁) such that there exists a witness w such that C(x₀, w)=x₁;
(iv) generating, using the at least one processor, a rate-1 somewhere extractable batch argument (seBARG) common reference string crs₁ for the language that contains all tuples (x₀, ⊥, x₁) for which there exists a SNARG proof π_{SNARG} that (x₀, x₁) is in L_{SNARG};
(v) generating, using the at least one processor, a series of rate-1 somewhere extractable batch argument (seBARG) common reference strings { [symbol] } where for each level [symbol] , the seBARG is for the language that contains tuples (x₀, x₁, x₂) for which there exist (x_{L}, π_{L}) and (x_{R}, π_{R}) such that π_{L} is a previous level seBARG for (x₀, x_{L}, x₁) and π_{R} is a previous level seBARG for (x₁, x_{R}, x₂);
(vi) storing the generated reference strings in the memory;
(vii) outputting, via an electronic interface, a combined common reference string
$$crs := ( {crs}_{SNARG} , {\{ {crs}_{ℓ} \}}_{ℓ ∈ [ {ℓ}_{max} ]} ) ;$$
(b) at a first prover entity comprising at least one computerized processor and memory and in electronic communication with the setup entity:
(i) receiving, via an electronic interface, the combined common reference string crs;
(ii) receiving, via an electronic interface, inputs x₀ and a witness w₀;
(iii) computing, using the at least one processor, a new state x₁=C(x₀, w₀);
(iv) generating, using the at least one processor, a SNARG proof π_{SNARG} at level 0 using crs_{SNARG} for (x₀, x₁) with witness w₀ and outputting this as Π₁;
(v) transmitting, via an electronic interface, Π₁ to a subsequent prover entity;
(c) at a subsequent prover entity comprising at least one computerized processor and memory and in communication with both the setup entity and the first prover entity or a previous prover entity:
(i) receiving, via an electronic interface, the combined common reference string crs;
(ii) receiving, via an electronic interface, inputs (x₀, xᵢ, i), a proof Πᵢ, and a witness wᵢ;
(iii) verifying, using the at least one processor, Πᵢ is a proof for (x₀, xᵢ, i) using the same method as the verifier entity;
(iv) computing, using the at least one processor, a new state xᵢ₊₁=C(xᵢ, wᵢ);
(v) generating, using the at least one processor, a SNARG proof π_{SNARG} at level 0 using crs_{SNARG} for (xᵢ, xᵢ₊₁);
(vi) merging, using the at least one processor, proofs Πᵢ and π_{SNARG} to create a higher-level proof by repeating the following process for all levels from 0 to [symbol] ₘₐₓ−1, where [symbol] ₘₐₓ is the maximum level of the proof hierarchy:
(a) checking if there are two proofs at level (and if not, continuing to the next level;
(b) verifying the adjacency of the two proofs by comparing end states and indices;
(c) for level 0 proofs, computing a level 1 somewhere extractable batch argument (seBARG) proof that combines the two level 0 proofs using the seBARG merging algorithm with crs₁;
(d) for proofs at level [symbol] greater than 1, computing a seBARG proof a level [symbol] +1 proof that combines the two proofs using the seBARG merging algorithm with [symbol] , including the intermediate state;
(e) adding the newly created higher-level proof to the set of proofs at the next level;
(vii) storing the merged proofs in the memory;
(viii) outputting, via an electronic interface, the merged proofs as a new proof Πᵢ;
(d) at a verifier entity comprising at least one computerized processor and memory and in electronic communication with the prover entity:
(i) receiving, via an electronic interface, the combined common reference string crs;
(ii) receiving, via an electronic interface, inputs (x₀, xₜ, t) and a proof It;
(iii) verifying, using the at least one processor, proofs at each level using the corresponding seBARG and SNARG verification algorithms;
(iv) outputting, via an electronic interface, a verification result.

2. The method of claim 1, wherein the succinct non-interactive argument (SNARG) common reference string crs_{SNARG} is generated using one of:
(a) a learning with errors (LWE) assumption with subexponential security parameter λ;
(b) a bilinear maps assumption with subexponential security parameter λ; or
(c) an indistinguishability obfuscation assumption with subexponential security parameter λ.

3. The method of claim 1, wherein the rate-1 somewhere extractable batch argument (seBARG) common reference strings { [symbol] are generated using one of:
(a) a learning with errors (LWE) assumption with subexponential security parameter λ;
(b) a bilinear maps assumption with subexponential security parameter λ; or
(c) a discrete logarithm assumption with subexponential security parameter λ.

4. The method of claim 1, wherein merging proofs at level [symbol] comprises:
(a) receiving a first proof π₁ for configurations ( [symbol] ) and a second proof π₂ for configurations ( [symbol] );
(b) verifying that the endpoint configuration [symbol] matches between the two proofs;
(c) computing a level [symbol] +1 somewhere extractable batch argument proof [symbol] that combines π₁ and π₂ using the seBARG merging algorithm with [symbol] ; and
(d) outputting the merged proof [symbol] along with configurations [symbol] , and [symbol] .

5. A method for verifying the execution of any distributed computation C across multiple untrusted nodes starting from a configuration x_0, wherein each node computes from the previous configuration x_i the next configuration x_i+1 dependent on C and a nondeterministic input w_i, additionally achieving zero knowledge for the witnesses used at each step of computation, the method comprising:
(a) at a setup entity comprising at least one computerized processor and memory:
(i) receiving, via an electronic interface, security parameters (1^{λ}, T), where λ is a security parameter, and T is an iteration bound;
(ii) calculating, using the at least one processor, [symbol] ₘₐₓ as a base-2 logarithm of T rounded up to the nearest integer as a representation of the maximum level of the proof hierarchy;
(iii) generating, using the at least one processor, a succinct non-interactive argument (SNARG) common reference string crs_SNARG for a language L_SNARG that contains all tuples (x_0, x_1) such that there exists a witness w such that C (x_0, w)=x_1;
(iv) computing, using the at least one processor, a public key and secret key pair (pk, sk) of a public key encryption (PKE) scheme;
(v) computing, using the at least one processor, a non-interactive zero knowledge (NIZK) common reference string crs_NIZK for a language L_NIZK that contains all tuples (ct_0, ct_1) for which there exist a tuple (x_0, x_1, r_0, r_1, T) such that ct_b=PKE.Enc(pk, x_b) with randomness r_b and π is a valid SNARG for (x_0, x_1);
(vi) generating, using the at least one processor, a rate-1 somewhere extractable batch argument (seBARG) common reference string crs_1 for the language that contains all tuples (ct_0, ⊥, ct_1) for which there exists a NIZK proof π_NIZK that (ct_0, ct_1) is in L_NIZK;
(vii) generating, using the at least one processor, a series of rate-1 somewhere extractable batch argument (seBARG) common reference strings {crs [symbol] } [symbol] ∈{2, . . . [symbol] ₘₐₓ} where for each level [symbol] , the seBARG is for the language that contains tuples (x_0, x_1, x_2) for which there exist (x_L, π_L) and (x_R, π_R) such that π_L is a previous level seBARG for (x_0, x_L, x_1) and π_R is a previous level seBARG for (x_1, x_R, x_2);
(viii) storing the generated reference strings in the memory;
(ix) outputting, via an electronic interface, a combined common reference string
$$crs := ( pk , crs\_SNARG , crs\_NIZK , \{ crs\_ℓ \} \_ℓ ∈ [ {ℓ}_{max} ] ) ;$$
(b) at a first prover entity comprising at least one computerized processor and memory and in electronic communication with the setup entity:
(i) receiving, via an electronic interface, the combined common reference string crs;
(ii) receiving, via an electronic interface, inputs x_0 and a witness w_0;
(iii) computing, using the at least one processor, a new state x_1=C(x_0, w_0);
(iv) sampling, using the at least one processor, randomness r_0 and r_1;
(v) computing, using the at least one processor, ct_0 as an encryption of x_0 under pk using randomness r_0, and computing ct_1 as an encryption of x_1 under pk using randomness r_1;
(vi) generating, using the at least one processor, a SNARG proof π_SNARG using crs_SNARG for (x_0, x_1) with witness w_0;
(vii) generating, using the at least one processor, a NIZK proof π_NIZK at level 0 of (ct_0, ct_1) using crs_NIZK and witness (x_0, x_1, x_0, x_1, π_SNARG);
(viii) storing the generated proofs in the memory;
(ix) outputting, via an electronic interface, (x_0, x_1, ct_0, ct_1, π_NIZK) as Π_1;
(c) at a subsequent prover entity comprising at least one computerized processor and memory and in communication with both the setup entity and the first prover entity or a previous prover entity:
(i) receiving, via an electronic interface, the combined common reference string crs;
(ii) receiving, via an electronic interface, inputs (x_0, x_i, i), a proof Π_i, and a witness w_i, where Π_i is of the form (r_0, r_i, ct_0, ct_i, S_i) where S_i is a set of NIZK and seBARG proofs;
(iii) verifying, using the at least one processor, Π_i is a proof for (x_0, x_i, i) using the same method as the verifier entity;
(iv) computing, using the at least one processor, a new state
$$x\_i + 1 = C ( x\_i , w\_i ) ;$$
(v) generating, using the at least one processor, a SNARG proof π_SNARG using crs_SNARG for (x_i, x_i+1);
(vi) sampling, using the at least one processor, randomness r_i+1;
(vii) computing, using the at least one processor, ct_i+1 as an encryption of x_i+1 under pk using randomness x_i+1;
(viii) generating, using the at least one processor, a NIZK proof π_NIZK at level 0 of (ct_i, ct_i+1) using crs_NIZK and witness (x_i, x_i+1, x_i, x_i, π_SNARG) where (ct_i, x_i) come from Π_i;
(ix) merging, using the at least one processor, proofs Π_i and π_NIZK to create a higher-level proof by repeating the following process for all levels from 0 to [symbol] ₘₐₓ−1, where [symbol] ₘₐₓ is the maximum level of the proof hierarchy:
(a) checking if there are two seBARG or NIZK proofs at level [symbol] in the proof set S_i of Π_i and if not, continuing to the next level;
(b) verifying the adjacency of the two proofs by comparing end states and indices;
(c) for level 0 proofs, computing a level 1 somewhere extractable batch argument (seBARG) proof that combines the two level 0 proofs using the seBARG merging algorithm with crs_1;
(d) for proofs at level [symbol] greater than 1, computing a seBARG proof a level [symbol] +1 proof that combines the two proofs using the seBARG merging algorithm with crs (+1, including the intermediate state;
(e) adding the newly created higher-level proof to the set of proofs at the next level;
(x) storing the merged proofs in the memory;
(xi) outputting, via an electronic interface, Π_i:=(r_0, r_i+1, ct_0, ct_i+1, S_i+1) where S_i+1 is the new set of merged seBARG and NIZK proofs at each level;
(d) at a verifier entity comprising at least one computerized processor and memory and in electronic communication with the prover entity:
(i) receiving, via an electronic interface, the combined common reference string crs;
(ii) receiving, via an electronic interface, inputs (x_0, x_t, t) and a proof Π_t, where Π_t is of the form (x_0, x_t, ct_0, ct_t, S_t) where S_t is a set of NIZK and seBARG proofs;
(iii) verifying, using the at least one processor, ct_0 is an encryption of x_0 under pk using r_0 and ct_t is an encryption of a t under pk using r_t;
(iv) verifying, using the at least one processor, proofs in S_t at each level using the corresponding NIZK and seBARG verification algorithms;
(v) outputting, via an electronic interface, a verification result.

6. The method of claim 5, wherein the succinct non-interactive argument (SNARG) common reference string crs_{SNARG} and the non-interactive zero knowledge (NIZK) common reference string crs_{NIZK} are generated using one of:
(a) a learning with errors (LWE) assumption with subexponential security parameter λ;
(b) a bilinear maps assumption with subexponential security parameter λ; or
(c) an indistinguishability obfuscation assumption with subexponential security parameter λ.

7. The method of claim 5, wherein the rate-1 somewhere extractable batch argument (seBARG) common reference strings { [symbol] are generated using one of:
(a) a learning with errors (LWE) assumption with subexponential security parameter λ;
(b) a bilinear maps assumption with subexponential security parameter λ; or
(c) a discrete logarithm assumption with subexponential security parameter λ.

8. The method of claim 5, wherein merging proofs at level [symbol] comprises:
(a) receiving a first proof π₁ for ciphertexts ( [symbol] ) and a second proof π₂ for ciphertexts ( [symbol] );
(b) verifying that the intermediate ciphertext [symbol] matches between the two proofs;
(c) computing a level [symbol] +1 somewhere extractable batch argument proof [symbol] that combines π₁ and π₂ using the seBARG merging algorithm with [symbol] ; and
(d) outputting the merged proof [symbol] along with ciphertexts ctᵢ, [symbol] , and [symbol] .

9. A system for verifying the execution of any distributed computation C across multiple untrusted nodes starting from a configuration x₀, wherein each node computes from the previous configuration xᵢ the next configuration xᵢ₊₁ dependent on C and a nondeterministic input wᵢ, the system comprising:
(a) a setup entity comprising:
(i) a computerized processor; and
(ii) a memory storing instructions that, when executed by the processor, cause the setup entity to:
(a) receive security parameters (1^{λ}, T), where λ is a security parameter, and T is an iteration bound;
(b) calculate [symbol] ₘₐₓ as a base-2 logarithm of T rounded up to the nearest integer as a representation of the maximum level of the proof hierarchy;
(c) generate a succinct non-interactive argument (SNARG) common reference string crs_{SNARG} for a language L_{SNARG} that contains all tuples (x₀, x₁) such that there exists a witness w such that C(x₀, w)=x₁;
(d) generate a rate-1 somewhere extractable batch argument (seBARG) common reference string crs₁ for the language that contains all tuples (x₀, ⊥, x₁) for which there exists a SNARG proof π_{SNARG} that (x₀, x₁) is in L_{SNARG};
(e) generate a series of rate-1 somewhere extractable batch argument (seBARG) common reference strings { [symbol] } where for each level [symbol] , the seBARG is for the language that contains tuples (x₀, x₁, x₂) for which there exist (x_{L}, π_{L}) and (x_{R}, π_{R}) such that π_{L} is a previous level seBARG for (x₀, x_{L}, x₁) and π_{R} is a previous level seBARG for (x₁, x_{R}, x₂);
(f) output a combined common reference string
$$crs := ( c r {s}_{SNARG} , {\{ {crs}_{ℓ} \}}_{ℓ ∈ [ {ℓ}_{max} ]} ) ;$$
(b) a first prover entity in electronic communication with the setup entity, comprising:
(i) a computerized processor; and
(ii) a memory storing instructions that, when executed by the processor, cause the first prover entity to:
(a) receive the combined common reference string crs;
(b) receive inputs x₀ and a witness w₀;
(c) compute a new state x₁=C(x₀, w₀);
(d) generate a SNARG proof π_{SNARG} at level 0 using crs_{SNARG} for (x₀, x₁) with witness w₀ and output this as Π₁;
(c) a subsequent prover entity in communication with both the setup entity and the first prover entity or a previous prover entity, comprising:
(i) a computerized processor; and
(ii) a memory storing instructions that, when executed by the processor, cause the subsequent prover entity to:
(a) receive the combined common reference string crs;
(b) receive inputs (x₀, xᵢ, i), a proof Πᵢ, and a witness wᵢ;
(c) verify It is a proof for (x₀, xᵢ, i) using the same method as the verifier entity;
(d) compute a new state xᵢ₊₁=C(xᵢ, wᵢ);
(e) generate a SNARG proof π_{SNARG} at level 0 using crs_{SNARG} for (xᵢ, xᵢ₊₁);
(f) merge proofs Πᵢ and π_{SNARG} to create a higher-level proof by repeating the following process for all levels from 0 to [symbol] ₘₐₓ−1:
(i) check if there are two proofs at level [symbol] and if not, continue to the next level;
(ii) verify the adjacency of the two proofs by comparing end states and indices;
(iii) for level 0 proofs, compute a level 1 somewhere extractable batch argument (seBARG) proof that combines the two level 0 proofs using the seBARG merging algorithm with crs₁;
(iv) for proofs at level [symbol] greater than 1, compute a seBARG proof at level [symbol] +1 that combines the two proofs using the seBARG merging algorithm with crs [symbol] ₊₁, including the intermediate state;
(v) add the newly created higher-level proof to the set of proofs at the next level;
(g) output the merged proofs as a new proof Πᵢ;
(d) a verifier entity in electronic communication with the prover entity, comprising:
(i) a computerized processor; and
(ii) a memory storing instructions that, when executed by the processor, cause the verifier entity to:
(a) receive the combined common reference string crs;
(b) receive inputs (x₀, xₜ, t) and a proof Πₜ;
(c) verify proofs at each level using the corresponding seBARG and SNARG verification algorithms;
(d) output a verification result.

10. The system of claim 9, wherein the succinct non-interactive argument (SNARG) common reference string crs_{SNARG} is generated using one of:
(a) a learning with errors (LWE) assumption with subexponential security parameter λ;
(b) a bilinear maps assumption with subexponential security parameter λ; or
(c) an indistinguishability obfuscation assumption with subexponential security parameter λ.

11. The system of claim 9, wherein the rate-1 somewhere extractable batch argument (seBARG) common reference strings { [symbol] are generated using one of:
(a) a learning with errors (LWE) assumption with subexponential security parameter λ;
(b) a bilinear maps assumption with subexponential security parameter λ; or
(c) a discrete logarithm assumption with subexponential security parameter λ.

12. The system of claim 9, wherein merging proofs at level [symbol] comprises:
(a) receiving a first proof π₁ for configurations ( [symbol] ) and a second proof π₂ for configurations ( [symbol] );
(b) verifying that the endpoint configuration [symbol] matches between the two proofs;
(c) computing a level [symbol] +1 somewhere extractable batch argument proof [symbol] that combines π₁ and π₂ using the seBARG merging algorithm with [symbol] ; and
(d) outputting the merged proof [symbol] along with configurations [symbol] , and [symbol] .

13. A system for verifying the execution of any distributed computation C across multiple untrusted nodes starting from a configuration x₀, wherein each node computes from the previous configuration xᵢ the next configuration xᵢ₊₁ dependent on C and a nondeterministic input wᵢ, additionally achieving zero knowledge for the witnesses used at each step of computation, the system comprising:
(a) a setup entity comprising:
(i) a computerized processor; and
(ii) a memory storing instructions that, when executed by the processor, cause the setup entity to:
(a) receive security parameters ( [symbol] , T), where λ is a security parameter, and T is an iteration bound;
(b) calculate [symbol] ₘₐₓ as a base-2 logarithm of T rounded up to the nearest integer as a representation of the maximum level of the proof hierarchy;
(c) generate a succinct non-interactive argument (SNARG) common reference string crs_{SNARG} for a language L_{SNARG} that contains all tuples (x₀, x₁) such that there exists a witness w such that C(x₀, w)=x₁;
(d) compute a public key and secret key pair (pk, sk) of a public key encryption (PKE) scheme;
(e) compute a non-interactive zero knowledge (NIZK) common reference string crs_{NIZK} for a language L_{NIZK} that contains all tuples (ct₀, ct₁) for which there exist a tuple (x₀, x₁, r₀, r₁, T) such that ct_{b}=PKE. Enc (pk, x_{b}) with randomness r_{b} and π is a valid SNARG for (x₀, x₁);
(f) generate a rate-1 somewhere extractable batch argument (seBARG) common reference string crs₁ for the language that contains all tuples (ct₀, ⊥, ct₁) for which there exists a NIZK proof π_{NIZK} that (ct₀, ct₁) is in L_{NIZK};
(g) generate a series of rate-1 somewhere extractable batch argument (seBARG) common reference strings { [symbol] where for each level [symbol] , the seBARG is for the language that contains tuples (x₀, x₁, x₂) for which there exist (x_{L}, π_{L}) and (x_{R}, πR) such that π_{L} is a previous level seBARG for (x₀, x_{L}, x₁) and π_{R} is a previous level seBARG for (x₁, x_{R}, x₂);
(h) output a combined common reference string
$$crs := ( pk , {crs}_{S NARG} , {crs}_{NIZK} , {\{ {crs}_{ℓ} \}}_{ℓ ∈ [ {ℓ}_{max} ]} ) ;$$
(b) a first prover entity in electronic communication with the setup entity, comprising:
(i) a computerized processor; and
(ii) a memory storing instructions that, when executed by the processor, cause the first prover entity to:
(a) receive the combined common reference string crs;
(b) receive inputs x₀ and a witness w₀;
(c) compute a new state x₁=C(r₀, w₀);
(d) sample randomness x₀ and r₁;
(e) compute ct₀ as an encryption of x₀ under pk using randomness x₀, and compute ct₁ as an encryption of r₁ under pk using randomness r₁;
(f) generate a SNARG proof π_{SNARG} using crs_{SNARG} for (x₀, x₁) with witness w₀;
(g) generate a NIZK proof π_{NIZK} at level 0 of (ct₀, ct₁) using crs_{NIZK} and witness (x₀, x₁, r₀, r₁, π_{SNARG});
(h) output (r₀, r₁, ct₀, ct₁, π_{NIZK}) as Π₁;
(c) a subsequent prover entity in communication with both the setup entity and the first prover entity or a previous prover entity, comprising:
(i) a computerized processor; and
(ii) a memory storing instructions that, when executed by the processor, cause the subsequent prover entity to:
(a) receive the combined common reference string crs;
(b) receive inputs (x₀, x₂, i), a proof Πᵢ, and a witness wᵢ, where Πᵢ is of the form (r₀, rᵢ, ct₀, ctᵢ, Sᵢ) where Sᵢ is a set of NIZK and seBARG proofs;
(c) verify Πᵢ is a proof for (x₀, xᵢ, i) using the same method as the verifier entity;
(d) compute a new state xᵢ₊₁=C(xᵢ, wᵢ);
(e) generate a SNARG proof π_{SNARG} using crs_{SNARG} for (xᵢ, xᵢ₊₁);
(f) sample randomness rᵢ₊₁;
(g) compute ctᵢ₊₁ as an encryption of xᵢ₊₁ under pk using randomness xᵢ₊₁;
(h) generate a NIZK proof π_{NIZK} at level 0 of (ctᵢ, ctᵢ₊₁) using crs_{NIZK} and witness (xᵢ, xᵢ₊₁, rᵢ, rᵢ, π_{SNARG}) where (ctᵢ, rᵢ) come from Πᵢ;
(i) merge proofs Πᵢ and π_{NIZK} to create a higher-level proof by repeating the following process for all levels from 0 to [symbol] ₘₐₓ−1:
(i) check if there are two seBARG or NIZK proofs at level [symbol] in the proof set Sᵢ of ℏᵢ and if not, continue to the next level;
(ii) verify the adjacency of the two proofs by comparing end states and indices;
(iii) for level 0 proofs, compute a level 1 somewhere extractable batch argument (seBARG) proof that combines the two level 0 proofs using the seBARG merging algorithm with crs₁;
(iv) for proofs at level [symbol] greater than 1, compute a seBARG proof at level [symbol] +1 that combines the two proofs using the seBARG merging algorithm with crs [symbol] ₊₁, including the intermediate state;
(v) add the newly created higher-level proof to the set of proofs at the next level;
(j) output Πᵢ:=(r₀, rᵢ₊₁, ct₀, ctᵢ₊₁, Sᵢ₊₁) where Sᵢ₊₁ is the new set of merged seBARG and NIZK proofs at each level;
(d) a verifier entity in electronic communication with the prover entity, comprising:
(i) a computerized processor; and
(ii) a memory storing instructions that, when executed by the processor, cause the verifier entity to:
(a) receive the combined common reference string crs;
(b) receive inputs (x₀, xₜ, t) and a proof Πₜ, where Πₜ is of the form (r₀, rₜ, ct₀, ctₜ, Sₜ) where St is a set of NIZK and seBARG proofs;
(c) verify ct₀ is an encryption of x₀ under pk using r₀ and ctₜ is an encryption of rt under pk using rt;
(d) verify proofs in St at each level using the corresponding NIZK and seBARG verification algorithms;
(e) output a verification result.

14. The system of claim 13, wherein the succinct non-interactive argument (SNARG) common reference string crs_{SNARG} and the non-interactive zero knowledge (NIZK) common reference string crs_{NIZK} are generated using one of:
(a) a learning with errors (LWE) assumption with subexponential security parameter λ;
(b) a bilinear maps assumption with subexponential security parameter λ; or
(c) an indistinguishability obfuscation assumption with subexponential security parameter λ.

15. The system of claim 13, wherein the rate-1 somewhere extractable batch argument (seBARG) common reference strings { [symbol] are generated using one of:
(a) a learning with errors (LWE) assumption with subexponential security parameter λ;
(b) a bilinear maps assumption with subexponential security parameter λ; or
(c) a discrete logarithm assumption with subexponential security parameter λ.

16. The system of claim 13, wherein merging proofs at level [symbol] comprises:
(a) receiving a first proof π₁ for ciphertexts ( [symbol] ) and a second proof π₂ for ciphertexts ( [symbol] );
(b) verifying that the intermediate ciphertext [symbol] matches between the two proofs;
(c) computing a level [symbol] +1 somewhere extractable batch argument proof [symbol] that combines π₁ and π₂ using the seBARG merging algorithm with [symbol] ; and
(d) outputting the merged proof [symbol] along with ciphertexts ctᵢ, [symbol] , and [symbol] .
